(19) United States
(12) Patent Application Publication
(10) Pub. No.: US 2020/0112077 A1
(43) Pub. Date: Apr. 9, 2020

(54) WAVEGUIDE DEVICE AND ANTENNA DEVICE

(71) Applicants: Nidec Corporation, Kyoto (JP); WGR Co., Ltd., Kyoto-city (JP)

(72) Inventors: Hiroyuki KAMO, Kyoto (JP); Hideki KIRINO, Kyoto-city (JP)

(21) Appl. No.: 16/590,455

(22) Filed: Oct. 2, 2019

(30) Foreign Application Priority Data
Oct. 4, 2018 (JP) 2018-189124

(51) Int. Cl. H01P 3/123; G01S 7/02; H01Q 13/02; H01Q 13/18; H01Q 21/06; H01Q 5/55; G01S 13/86

(52) U.S. Cl. CPC H01P 3/123; G01S 7/02; H01Q 13/02; G01S 13/867; H01Q 21/064; H01Q 5/55; H01Q 13/18

(57) ABSTRACT

A waveguide device includes a first electrically conductive member including an electrically conductive surface and a first through hole, a second electrically conductive member including electrically conductive rods each including a leading end opposing the electrically conductive surface, and a second through hole which overlaps the first through hole as viewed along an axial direction of the first through hole, an electrically-conductive waveguiding wall surrounding at least a portion of a space between the first through hole and the second through hole, the waveguiding wall being surrounded by the electrically conductive rods and allowing an electromagnetic wave to propagate between the first through hole and the second through hole. The waveguiding wall includes a stepped portion on the inner side.

### CROSS REFERENCE TO RELATED APPLICATION

The present invention claims priority under 35 U.S.C. § 119 to Japanese Application No. 2018-189124 filed on Oct. 4, 2018 the entire contents of which are incorporated herein by reference.

### 1. Field of the Invention

The present disclosure relates to a waveguide device and an antenna device.

### 2. Background

The specification of U.S. Pat. No. 8,779,995, the specification of U.S. Pat. No. 8,803,638, the specification of European Patent Application Publication No. 1 331 688, the specification of U.S. Pat. No. 10,027,032, the specification of U.S. Patent Publication No. 2018/375219, each disclose a waveguide device in which an electromagnetic wave propagates along a ridge that is surrounded by an artificial magnetic conductor. In the waveguide devices disclosed in the specification of U.S. Pat. No. 8,779,995, the specification of U.S. Pat. No. 8,803,638, the specification of European Patent Application Publication No. 1 331 688, the specification of U.S. Pat. No. 10,027,032, the specification of US Patent Publication No. 2018/375219, a plurality of electrically conductive rods that are arranged along row and column directions constitute an artificial magnetic conductor. Each of these waveguide devices, as a whole, includes a pair of opposing electrically conductive plates. One of the electrically conductive plates has a ridge that protrudes toward the other electrically conductive plate, and an artificial magnetic conductor that are located on both sides of the ridge. Via a gap, an upper face (which is an electrically-conductive face) of the ridge is opposed to the electrically conductive surface of the other electrically conductive plate. An electromagnetic wave having a wavelength that falls within a propagation-restricted band of the artificial magnetic conductor propagates in a space (gap) between this electrically conductive surface and the upper face of the ridge, in a manner of following along the ridge. A waveguide of this kind will be referred to as a WRG (Waffle-iron Ridge waveguide) or a WRG waveguide.

The specification of U.S. Patent Publication No. 2018/375219 discloses a waveguide device in which two electrically conductive plates opposing each other both have a through hole, such that an electrically-conductive waveguiding wall that surrounds at least a part of the space between such through holes is provided. Through the space surrounded by the waveguiding wall, an electromagnetic wave can be propagated between a plurality of layers.

### SUMMARY

Example embodiments of the present disclosure provide techniques of improving impedance matching in waveguide devices in each of which an electromagnetic wave is propagated between a plurality of layers.

A waveguide device according to an example embodiment of the present disclosure includes a first electrically conductive member including an electrically conductive surface and a first through hole, a second electrically conductive member including a plurality of electrically conductive rods, each of the first electrically conductive member and the second electrically conductive member including a leading end opposing the electrically conductive surface, and a second through hole which overlaps the first through hole as viewed along an axial direction of the first through hole, and an electrically-conductive waveguiding wall surrounding at least a portion of a space between the first through hole and the second through hole, the waveguiding wall being surrounded by the plurality of electrically conductive rods and allowing an electromagnetic wave to propagate between the first through hole and the second through hole. The waveguiding wall includes a stepped portion or a slope on an inner side.

An antenna device according to an example embodiment of the present disclosure includes a first electrically conductive member including a first electrically conductive surface on a front side, a second electrically conductive surface on a rear side, and a slot extending through and between the first electrically conductive surface and the second electrically conductive surface. The first electrically conductive surface has a shape that defines a horn surrounding the slot. The horn includes a pair of inner wall surfaces extending along a first direction which is perpendicular or substantially perpendicular to an E plane of the slot. A root of each of the pair of inner wall surfaces includes a protrusion extending along the first direction.

An antenna device according to still another example embodiment of the present disclosure includes an electrically conductive member including a first electrically conductive surface on a front side, a second electrically conductive surface on a rear side, and one or more slots extending through and between the first electrically conductive surface and the second electrically conductive surface. The first electrically conductive surface has a shape that defines one or more horns respectively surrounding the one or more slots, and two recesses located on opposite sides of the one or more horns. The one or more horns and the two recesses are arranged side by side in one row, with electrically conductive walls being located therebetween. Each of the electrically conductive walls located between the one or more horns and two recesses includes a central portion and sites on opposite sides of the central portion, the central portion and sites being distanced by two grooves.

According to example embodiments of the present disclosure, impedance matching in waveguide devices in each of which an electromagnetic wave is propagated between a plurality of layers is improved.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view of a waveguide device according to an example embodiment of the present disclosure.

FIG. 2 is a side view of a waveguide device according to an example embodiment of the present disclosure.

FIG. 3 is a plan view of a first conductive member according to an example embodiment of the present disclosure.

FIG. 4 is a plan view showing the rear side of a first conductive member according to an example embodiment of the present disclosure.

FIG. 5A is a perspective view of a transmission section according to an example embodiment of the present disclosure.

FIG. 5B is a plan view of a transmission section according to an example embodiment of the present disclosure.

FIG. 6 is a diagram showing enlarged the structure of a horn of an antenna element according to an example embodiment of the present disclosure.

FIG. 7 is a cross-sectional view taken along line A-A′ in FIG. 6.

FIG. 8 is a perspective view of a waveguiding wall according to an example embodiment of the present disclosure.

FIG. 9 is a perspective view showing the structure on the rear side of the first conductive member.

FIG. 10 is a plan view of a second conductive member according to an example embodiment of the present disclosure.

FIG. 11 is a partially enlarged plan view of the second conductive member.

FIG. 12 is a plan view of a third conductive member according to an example embodiment of the present disclosure.

FIG. 13 is a cross-sectional view showing a variant of FIG. 7.

FIG. 14 is a perspective view schematically showing an exemplary fundamental construction of a waveguide device according to an example embodiment of the present disclosure.

FIG. 15A is a diagram schematically showing a cross-sectional construction of the waveguide device as taken parallel to the XZ plane.

FIG. 15B is a diagram schematically showing another cross-sectional construction of the waveguide device as taken parallel to the XZ plane.

FIG. 16 is a perspective view schematically showing the waveguide device, illustrated so that the spacing between the first conductive member and the second conductive member is exaggerated.

FIG. 17 is a diagram showing an example range of dimension of each member in the structure shown in FIG. 15A.

FIG. 18A is a cross-sectional view showing an example structure according to an example embodiment of the present disclosure in which only the waveguide face of the waveguide member is electrically conductive, while any portion of the waveguide member other than the waveguide face is not electrically conductive.

FIG. 18B is a diagram showing a variant according to an example embodiment of the present disclosure in which the waveguide member is not formed on the second conductive member.

FIG. 18C is a diagram showing an example structure according to an example embodiment of the present disclosure where the second conductive member, the waveguide member, and each of the plurality of conductive rods are composed of a dielectric surface that is coated with an electrically conductive material such as a metal.

FIG. 18D is a diagram showing an example structure according to an example embodiment of the present disclosure in which the surface of metal conductive members, which are electrical conductors, are covered with a dielectric layer.

FIG. 18E is a diagram showing an example according to an example embodiment of the present disclosure where the second conductive member is structured so that the surface of members which are composed of a dielectric, e.g., resin, is covered with an electrical conductor such as a metal, this metal layer being further coated with a dielectric layer.

FIG. 18F is a diagram showing an example according to an example embodiment of the present disclosure where the height of the waveguide member is lower than the height of the conductive rods, and the portion of the conductive surface of the first conductive member that is opposed to the waveguide face protrudes toward the waveguide member.

FIG. 18G is a diagram showing an example according to an example embodiment of the present disclosure where, further in the structure of FIG. 18F, portions of the conductive surface that are opposed to the conductive rods protrude toward the conductive rods.

FIG. 19A is a diagram showing an example according to an example embodiment of the present disclosure where a conductive surface of the first conductive member is shaped as a curved surface.

FIG. 19B is a diagram showing an example according to an example embodiment of the present disclosure where also a conductive surface of the second conductive member is shaped as a curved surface.

FIG. 20A is a diagram schematically showing an electromagnetic wave that propagates in a narrow space, i.e., a gap between the waveguide face of the waveguide member and the conductive surface of the first conductive member.

FIG. 20B is a diagram schematically showing a cross section of a hollow waveguide according to an example embodiment of the present disclosure.

FIG. 20C is a cross-sectional view showing an implementation according to an example embodiment of the present disclosure where two waveguide members are provided on the second conductive member.

FIG. 20D is a diagram schematically showing a cross section of a waveguide device according to an example embodiment of the present disclosure in which two hollow waveguides are placed side-by-side.

FIG. 21A is a perspective view schematically showing a portion of the construction of an antenna device according to an example embodiment of the present disclosure.

FIG. 21B is a diagram showing schematically showing a portion of a cross-sectional construction as taken parallel to an XZ plane which passes through the centers of two adjacent slots along the X direction of the antenna device.

FIG. 22A is a diagram showing an example of an antenna device according to an example embodiment of the present disclosure in which a plurality of slots are arrayed. FIG. 22A is an upper plan view showing the antenna device as viewed from the +Z direction.

FIG. 22B is a cross-sectional view taken along line B-B in FIG. 22A.

FIG. 23A is a diagram showing a planar layout of the waveguide members and conductive rods on the first conductive member.

FIG. 23B is a diagram showing a planar layout of the conductive rods, the waveguiding wall, and the through hole on the second conductive member.

FIG. 23C is a diagram showing a planar layout of the waveguide member and the conductive rods on the third conductive member.

FIG. 24A is a perspective view showing one radiating element of a slot antenna device according to according to an example embodiment of the present disclosure.

FIG. 24B is a diagram illustrated so that the spacing between the conductive members is exaggerated in the radiating element of FIG. 24A.

FIG. 25 is a diagram showing variations of through holes according to an example embodiment of the present disclosure.

### DETAILED DESCRIPTION

Hereinafter, specific exemplary constructions according to example embodiments of the present disclosure will be described. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art. The accompanying drawings and the following description, which are provided by the inventors so that those skilled in the art can sufficiently understand the present disclosure, are not intended to limit the scope of claims. In the present specification, identical or similar constituent elements are denoted by identical reference numerals.

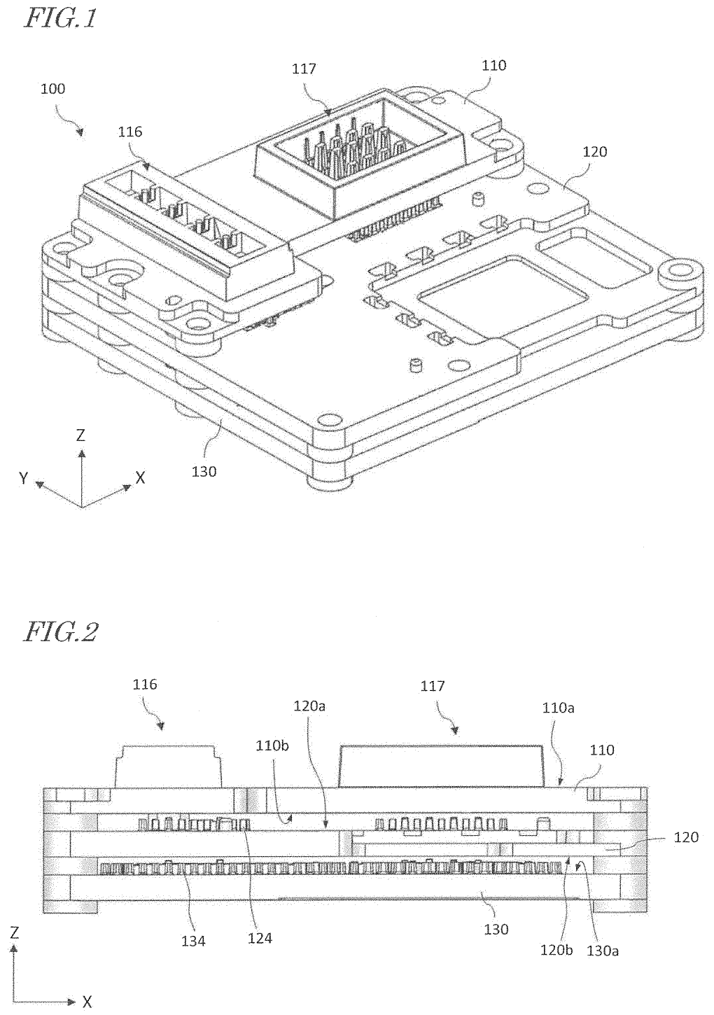

FIG. 1 schematically shows a waveguide device 100 according to an illustrative example embodiment of the present disclosure. The waveguide device 100 is used to propagate electromagnetic waves. The waveguide device 100 functions as an antenna device having a transmission section 116 and a reception section 117. Each of the transmission section 116 and the reception section 117 has one or more antenna elements. In the example of FIG. 1, the transmission section 116 and the reception section 117 each have a plurality of antenna elements. Each antenna element of the transmission section 116 allows an electromagnetic wave that has propagated through a waveguide inside the waveguide device 100 to be radiated to external space. Each antenna element in the reception section 117 receives an electromagnetic wave that arrives from external space, and propagates it to a waveguide inside the waveguide device 100.

In FIG. 1 and the subsequent figures show XYZ coordinates along X, Y and Z directions which are orthogonal to one another. Hereinafter, the structure of the waveguide device 100 will be described by using these XYZ coordinates. Note that any structure appearing in a figure of the present application is shown in an orientation that is selected for ease of explanation, which in no way should limit its orientation when an example embodiment of the present disclosure is actually practiced. Moreover, the shape and size of a whole or a part of any structure that is shown in a figure should not limit its actual shape and size.

In the following description, “the front side” means the side at which an electromagnetic wave is radiated or the side at which an electromagnetic wave arrives, whereas “the rear side” means the opposite side to the front side. In the present example embodiment, the front side is the side in the +Z direction, whereas the rear side is the side in the −Z direction.

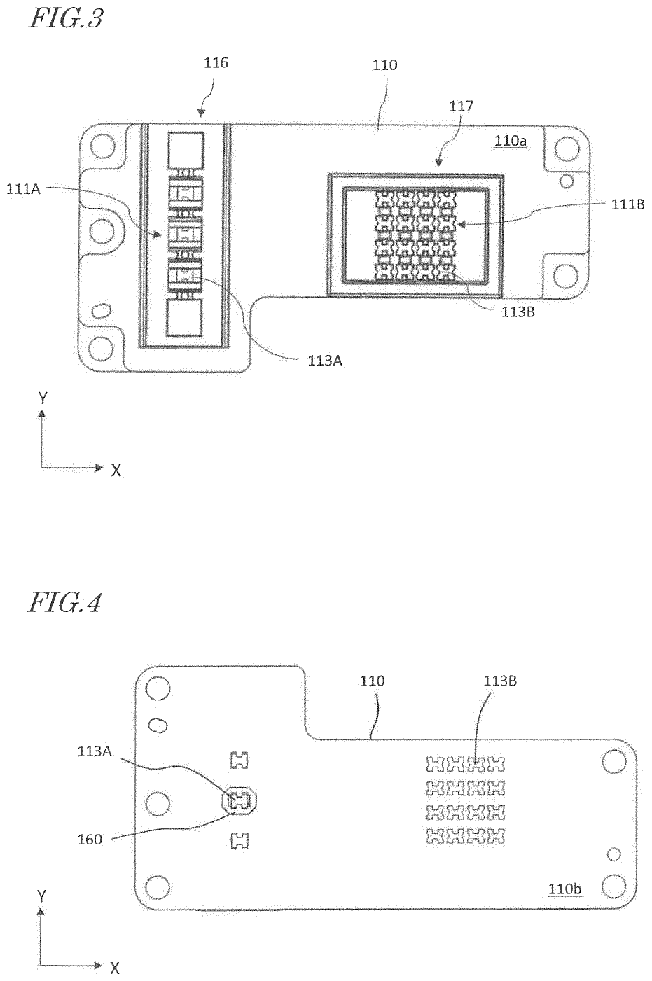

FIG. 2 is a side view showing the structure of the waveguide device 100 as viewed from the −Y direction. The waveguide device 100 of the present example embodiment has a structure in which a plurality of plate-like electrically conductive members are layered. The waveguide device 100 includes a first electrically conductive member 110, a second electrically conductive member 120, and a third electrically conductive member 130. The first conductive member 110, the second conductive member 120, and the third conductive member 130 are layered in this order, with gaps therebetween. Each conductive member is shaped by machining a metal plate, for example. Alternatively, each conductive member may be produced by plating a shaped dielectric member, e.g. resin. Each conductive member may have an electrically conductive surface on each of the front side and the rear side.

The first conductive member 110 has a transmission section 116 and a reception section 117 on its face on the front side (i.e., the +Z side). The first conductive member 110 has flat conductive surfaces 110a and 110b, respectively on its face on the front side and the opposite face thereof. The conductive surface 110b on the rear side is opposed to the conductive surface 120a on the +Z side of the second conductive member 120. The second conductive member 120 includes a plurality of electrically conductive rods 124 each having a leading end opposing the conductive surface 110b of the first conductive member 110. The second conductive member 120 also has a conductive surface 120b on its face on the -Z side. The conductive surface 120b is opposed to the conductive surface 130a of the third conductive member 130 on the +Z side. The third conductive member 130 includes a plurality of conductive rods 134 each having a leading end opposing the conductive surface 120b of the second conductive member 120 on the −Z side.

FIG. 3 is a plan view showing the structure on the radiation side of the first conductive member 110. In the transmission section 116, the first conductive member 110 includes a plurality of antenna elements 111A that are arranged side by side along the Y direction. Each antenna element in the present example embodiment is a horn antenna element. Although the transmission section 116 includes three antenna elements 111A in the illustrated example, the number of antenna elements 111A in the transmission section 116 is not limited to three.

In the reception section 117, the first conductive member 110 includes a plurality of antenna elements 111B that are arranged in a two-dimensional array along the X direction and the Y direction. In the illustrated example, the reception section 117 includes 16 antenna elements 111B that are arranged in 4 rows by 4 columns; however, the number of antenna elements 111B in the reception section 117 is not limited to sixteen. Although the waveguide device 100 of the present example embodiment has both of the transmission section 116 and the reception section 117, it may only have either one of them.

FIG. 4 shows a structure of the first conductive member 110 on the rear side (the −Z side). Each antenna element has a plurality of through holes which extend through the conductive surface 110a on the front side and the conductive surface 110b on the rear side of the first conductive member 110. The plurality of through holes include 3 through holes 113A in the transmission section 116 and 16 through holes 113B in the reception section 117. The through holes 113A in the transmission section 116 are referred to as the “first through holes 113A”. Although the through holes 113A and 113B are illustrated as each having an H shape, their shape is not limited to an H shape. In the present specification, the through holes 113A and 113B in the first conductive member 110 may be referred to as “slots”.

Among the three through holes 113A arranged side by side along the Y direction, the through hole 113A in the middle is surrounded by a waveguiding wall 160. The waveguiding wall 160 is connected to the conductive surface 110b on the rear side. The waveguiding wall 160 may be formed integrally with the first conductive member 110, so as to constitute a part of the first conductive member 110. The waveguiding wall 160 may be produced as an independent member from the first conductive member 110, and thereafter mounted on the first conductive member 110.

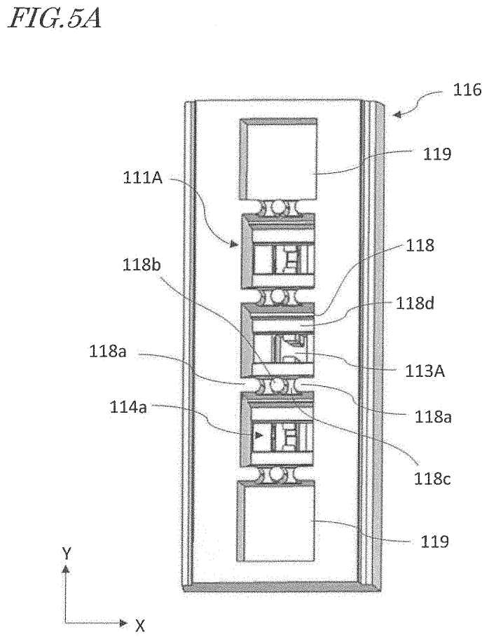

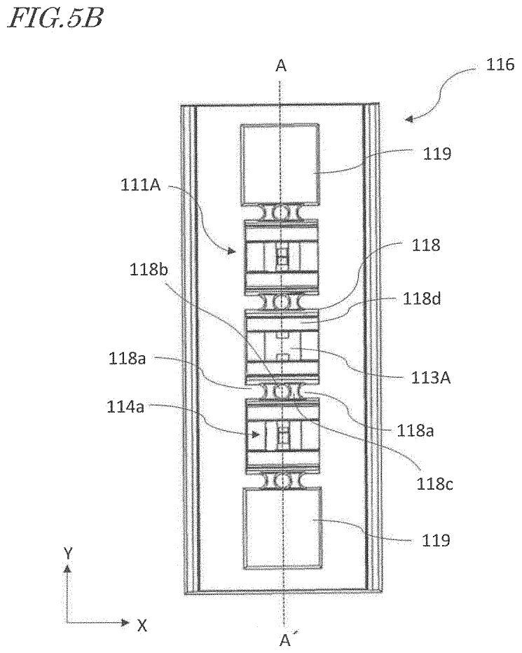

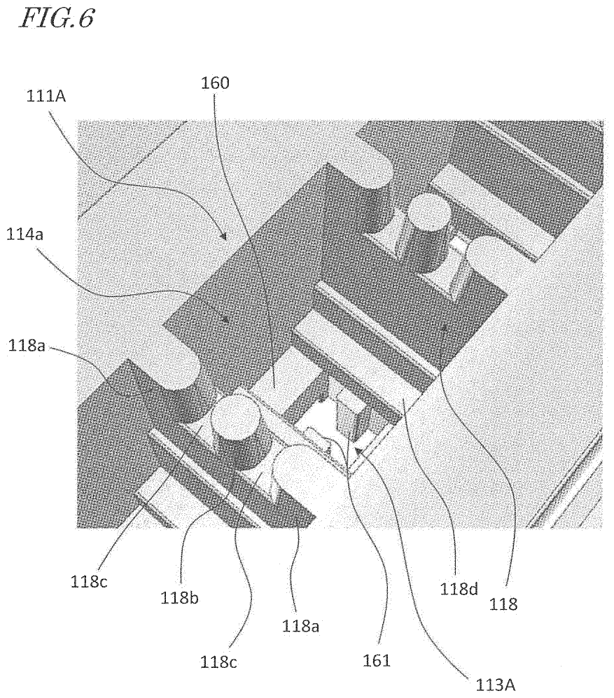

FIG. 5A and FIG. 5B are diagrams showing enlarged the structure of the transmission section 116 as viewed from the front side. FIG. 6 is a diagram showing enlarged the structure of a horn of an antenna element 111A in the transmission section 116. Each antenna element 111A has an aperture 114a that opens on the front side. Each aperture is defined by electrically conductive walls 118, so as to have a rectangular opening shape. In each antenna element 111A, the first through hole 113A and the aperture 114a are continuous. On the inner side of the conductive walls 118, each antenna element 111A has protrusions 118d extending along the X direction, thus presenting a staircase-like structure.

The conductive wall 118 being located on either side (regarding the Y direction) of each antenna element 111A and extending along the X direction includes a central portion and grooves 118c which are formed on opposite sides of the central portion. As viewed from the +Z direction, the central portion of the conductive wall 118 is at a position that is shifted along the oscillation direction (i.e., the Y direction) of the electric field from the center of the first through hole 113A. The grooves 118c can be formed by removing portions of the conductive wall 118 by cutting, for example. The top of each conductive wall 118 extending along the X direction is partitioned by the two grooves 118c into a conductive wall 118b (which is the central portion) and conductive walls 118a.

The following effects are attained by providing the grooves 118c, so as to leave a central portion, in the conductive wall 118 being located on either side (regarding the Y direction) of each antenna element 111A and extending along the X direction. First, isolation between electromagnetic waves to be radiated from the three antenna elements 111A is improved. Stated otherwise, electromagnetic waves can be restrained from propagating or leaking in any direction other than the desired direction. Furthermore, the frequency characteristics of the three antenna elements 111A can be stabilized. For example, a stable directivity can be realized even with varying frequencies.

In the present example embodiment, the exposed face of each conductive wall 118a (i.e., the face opposing the side face of the conductive wall 118b) is a curved surface. On the other hand, the conductive wall 118b is cylindrical. The shapes of the conductive walls 118a and 118b are not limited to the illustrated shapes. For example, the shape of the conductive wall 118b may be a prismatic shape, a frustum of a cone, or a frustum of a pyramid. The depth and width of each groove 118c are set to dimensions such that desired radiation characteristics will be provided.

As shown in FIG. 5A and FIG. 5B, the first conductive member 110 of the waveguide device 100 of the present example embodiment has two recesses 119 on opposite sides of the set of three antenna elements 111A. These recesses and the three antenna elements 111A are arranged side by side in one row. Each recess 119 has an opening shape similar to the aperture 114a of each antenna element 111A. However, no through hole exists inside each recess 119. Between each recess 119 and an adjoining antenna element 111A, a conductive wall 118 extending along the X direction exists, the conductive wall 118 also having the two aforementioned grooves 118c. With such structure, the three antenna elements 111A arranged along the Y direction can be equalized in terms of radiation characteristics.

In the present example embodiment, the first conductive member 110 is illustrated as including more than one antenna element 111A for transmission purposes; however, the first conductive member 110 may only include a single antenna element 111A. In that case, too, two recesses 119 having an opening of a similar shape to the opening of that antenna element 111A may be provided on both sides of the antenna element 111A. Between each recess 119 and the antenna element 111A, a conductive wall 118 having two grooves 118c as aforementioned may be provided. With such structure, isolation between electromagnetic waves to be radiated can be enhanced, and the frequency characteristics can be improved.

FIG. 7 is a cross-sectional view taken along line A-A′ in FIG. 6. The second conductive member 120 has second through holes 123, which overlap with the respective first through holes 113A as viewed along the axial direction of the first through holes 113A. Herein, the axis of each first through hole 113A is a straight line which passes through the center of the first through hole 113A and which is parallel to the Z direction. The first through hole 113A and the second through hole 123 together function as a waveguide. Among the three illustrated antenna elements 111A, the antenna element 111A in the middle has the waveguiding wall 160 provided on the rear side thereof. The waveguiding wall 160 may surround at least a part of the space between first through hole 113A and the second through hole 123, without having to entirely surround this space. With such construction, the waveguiding wall 160 allows an electromagnetic wave to be propagated between the first through hole 113A and the second through hole 123. In the example of FIG. 7, the site corresponding to the waveguiding wall 160 is shown with a different type of hatching from that of the first conductive member 110 and the second conductive member 120; it should be understood that this is for easier visual distinction of the waveguiding wall 160, rather than meaning that the waveguiding wall 160 is a different member from the first conductive member 110 and second conductive member 120.

The waveguiding wall 160 does not need to be entirely electrically conductive; it suffices if its end face 165 opposing the conductive surface 120a of the second conductive member 120 is electrically-conductive material.

In the example of FIG. 7, one end of the waveguiding wall 160 is connected to the conductive surface 110b of the first conductive member 110. An interspace exists between the end face 165 of the waveguiding wall 160 and the conductive surface 120a of the second conductive member 120. Alternatively, without providing an interspace between the end face 165 of the waveguiding wall 160 and the conductive surface 120a of the second conductive member 120, the end face 165 of the waveguiding wall 160 may be kept in contact with the conductive surface 120a of the second conductive member 120. In that case, too, proper functionality as an antenna is obtained.

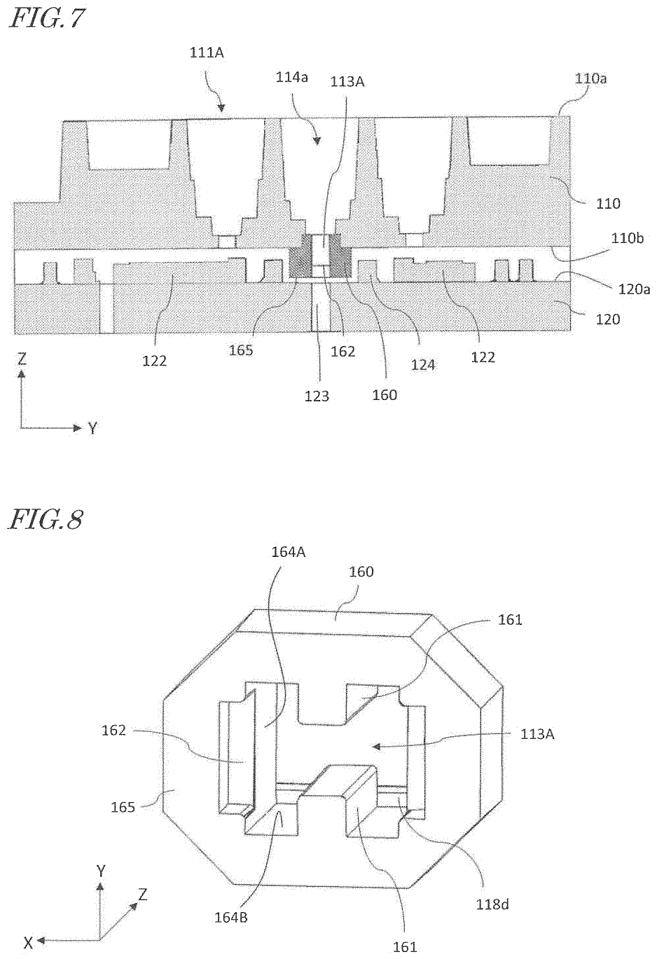

FIG. 8 is a perspective view showing the waveguiding wall 160 enlarged. The waveguiding wall 160 surrounds the first through hole 113A. The waveguiding wall 160 shown in FIG. 8 has its corners chamfered, such that the end face 165 has an octagonal shape. However, the shape of the waveguiding wall 160 is not limited to the illustrated shape. The corners of the waveguiding wall 160 may be chamfered into curved surfaces. However, as the curved surface portion in each corner increases, there is a tendency that the computational load for the simulation to be performed during design of the waveguide device 100 may increase. Therefore, the computational load for the simulation can be reduced as the angle of intersection of the corner becomes closer to 90 degrees.

On the inner side, the waveguiding wall 160 has a pair of first inner wall surfaces 164A which are parallel or substantially parallel to the Y direction (i.e., the E plane direction) and a pair of second inner wall surfaces 164B which are parallel or substantially parallel to the X direction (i.e., the H plane direction). Each of the pair of first inner wall surfaces 164A has a stepped portion 162 extending in parallel to the Y direction, the stepped portion 162 constituting a recessed portion of the waveguiding wall 160. The stepped portions 162 serve to expand the rear side (the −Z side) of the first through hole 113A. By thus providing the stepped portions 162 on the inner side of the waveguiding wall 160, impedance matching is improved.

As used herein, the “E plane” is a plane that contains electric field vectors to be created in the central portion of the first through hole 113A (slot), such that the E plane extends through the center of the first through hole 113A and is substantially perpendicular to the conductive surface 110b of the first conductive member 110. The “H plane” is a plane that contains magnetic field vectors to be created in the central portion of the first through hole 113A. In the present example embodiment, the E plane is parallel to the YZ plane, whereas the H plane is parallel to the XZ plane.

Although the stepped portion 162 in the present example embodiment includes a single step, it may alternatively include two or more steps. Moreover, the shape of the stepped portion 162 is not limited to what is shown. So long as impedance matching is achieved, the shape of the stepped portion 162 may be altered as appropriate. Without being limited to a staircase, the shape of the inner side of the waveguiding wall 160 may be an inclined plane, for example. Similar effects can also be obtained by adopting a structure with a pair of slopes that allow the opening to gradually expand in the −Z direction, instead of the stepped portion 162 shown in FIG. 8.

On the front side (the +Z side) of the pair of second inner wall surfaces 164B, a pair of protrusions 118d are provided that protrude from the inner wall surface of the first through hole 113A (which is continuous with the pair of second inner wall surfaces 164B) and extend along the X direction. FIG. 8 only reveals one of the pair of protrusions 118d, and it should be understood that a similar protrusion 118d also exists at the +Y side. The protrusions 118d are located at the root of the conductive wall 118 of the antenna element 111A, as can be understood from FIG. 6. The waveguiding wall 160 includes a pair of ridge portions 161 that protrude from the respective central portions of the pair of second inner wall surfaces 164B and extend along the Z direction. The end face of the ridge portion 161 at the +Z side and the side face of the protrusion 118d at the −Z side are continuous, thereby constituting the staircase structure that is illustrated in FIGS. 5A through 6.

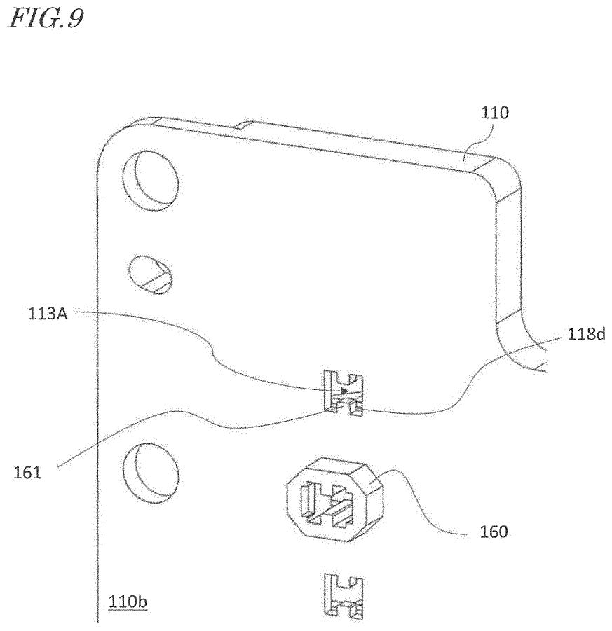

FIG. 9 is a diagram showing the structure on the rear side of the first conductive member 110. As shown in FIG. 9, any first through hole 113A that lacks the waveguiding wall 160 may also have protrusions 118d on the inner side. Without being limited to a staircase structure, each protrusion 118d may alternatively construct a sloped structure. The protrusions 118d serve to gradually expand the size of the gap, as going from the pair of ridge portions 161 of the antenna element toward the edge at the front side (the +Z side) of the aperture. By providing such protrusions 118d, impedance matching can be further improved.

Details of the structure and possible variants of the waveguiding wall 160 are disclosed in the specification of U.S. Patent Publication No. 2018/375219. The entire disclosure of the specification of U.S. Patent Publication No. 2018/375219 is incorporated herein by reference.

Thus, the waveguiding wall 160 in the present example embodiment includes the pair of first inner wall surfaces 164A which are parallel to the E plane and the pair of second inner wall surfaces 164B which are parallel to the H plane. The waveguiding wall 160 includes one or more stepped portions or one or more slopes on the inner side. The stepped portions or slopes are disposed on the pair of first inner wall surfaces 164A. As viewed from a direction which is perpendicular to the conductive surface 110b of the first conductive member 110, the region that is surrounded by the first and second through holes 113A and 123 and the inner wall surface of the waveguiding wall 160 has an H shape that includes a lateral portion extending along a first direction and a pair of vertical portions extending from both ends of the lateral portion along a second direction which intersects the first direction. The inner wall surface of the waveguiding wall 160 includes a pair of first inner wall surfaces 164A that are parallel to the pair of vertical portions. The stepped portions or slopes are disposed on an edge of the pair of first inner wall surfaces 164A by which the second conductive member 120 is located.

The antenna device according to the present example embodiment includes the first conductive member 110 having the first conductive surface 110a on the front side, the second conductive surface 110b on the rear side, and one or more slots 113A extending through and between the first conductive surface 110a and the second conductive surface 110b. The first conductive surface 110a has a shape that defines one or more horns respectively surrounding the one or more slots 113A. Each horn has a pair of inner wall surfaces 118 extending along a first direction which is perpendicular or substantially perpendicular to the E plane of the slot. The root of each of the pair of inner wall surfaces 118 has a protrusion 118d extending along the first direction.

As shown in FIG. 5A and FIG. 5B, the first conductive surface 110a may have a shape that further defines, in addition to the one or more horns, two recesses 119 located on opposite sides of the one or more horns. The one or more horns and the two recesses 119 are arranged side by side in one row. Each conductive wall 118 located between the one or more horns and two recesses 119 has a central portion 118b and sites 118a on opposite sides of the central portion 118b, the central portion 118b and sites 118a being distanced by the two grooves 118c.

The waveguide device 100 may further include a second conductive member 120 having a third conductive surface 120a opposing the second conductive surface 110b. The second conductive member 120 includes a through hole for allowing an electromagnetic wave to propagate reciprocally between itself and the slot, or a waveguide member defining a ridge waveguide for allowing an electromagnetic wave to propagate reciprocally between itself and the slot.

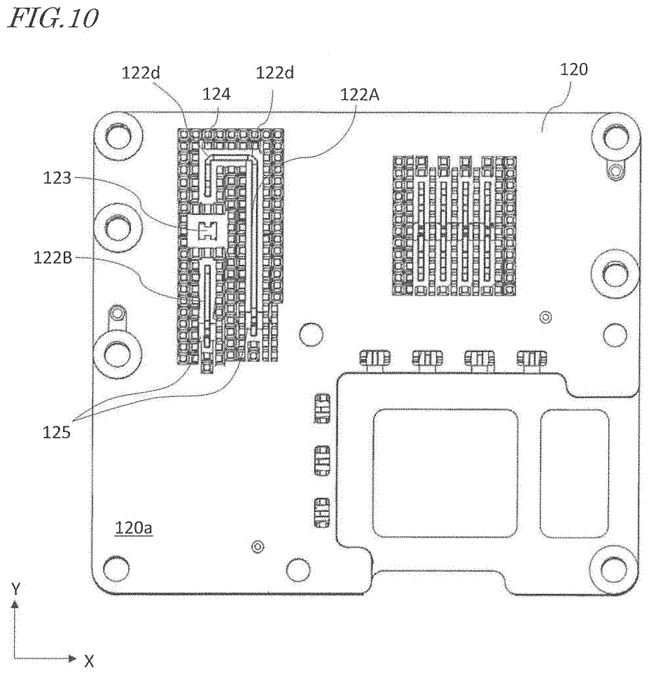

FIG. 10 is a plan view showing the second conductive member 120 as viewed from the +Z side. In a portion on the second conductive member 120 corresponding to the transmission section 116, a first ridge 122A and a second ridge 122B are disposed, which are waveguide members. The first ridge 122A in the illustrated example has two bends 122d. The second ridge 122B has a straight line-like structure.

The first ridge 122A and the second ridge 122B has an upper face (hereinafter referred to as a “waveguide face”) opposing the conductive surface 110b of the first conductive member 110. The waveguide face of each ridge has a plurality of recesses. Each of the first ridge 122A and the second ridge 122B has a port 125 (i.e., a through hole) provided at one end. Although the ports 125 are shown to have an H shape in the illustrated example, its shape is not limited thereto.

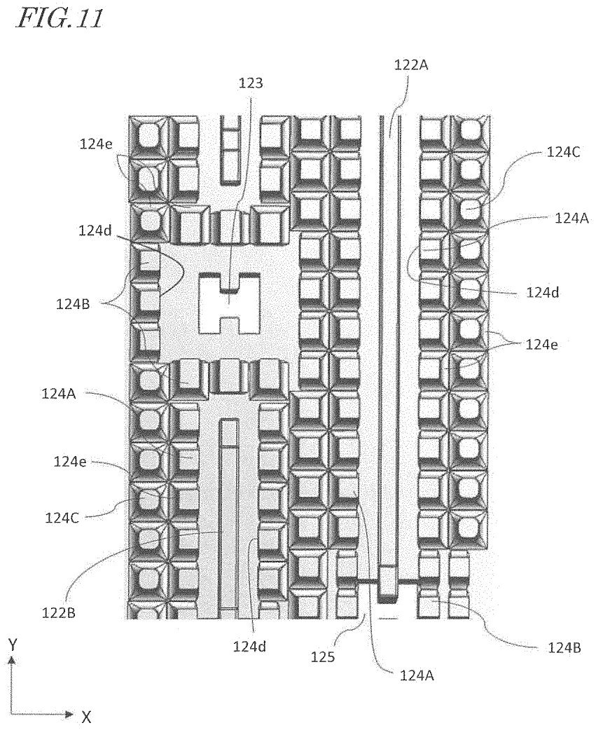

A plurality of electrically-conductive rods 124 are provided on the second conductive member 120. The plurality of rods 124 surround the first ridge 122A, the second ridge 122B, the second through holes 123, and the ports 125. FIG. 11 is a partially enlarged view of FIG. 10. As shown in FIG. 11, the plurality of rods 124 include: ridge-side rods (first rods) 124A which are disposed along the side faces of the first ridge 122A and the second ridge 122B at positions near the ridges; through hole-side rods (second rods) 124B disposed at positions near the second through holes 123 and the ports 125; and other rods (hereinafter referred to as “third rods”) 124C. These rods 124 are arranged in a two-dimensional array on the conductive surface 120a of the second conductive member 120, along the X and Y directions.

The third rods 124C have their corners significantly chamfered. Each third rod 124C is shaped so that its cross section parallel to the XY plane is gradually pointed. In a cross section taken perpendicular to the axial direction of each third rod 124C, the dimensions of its outer shape decrease from the root toward the leading end of the third rod 124C. As used herein, the axis of a rod refers to a straight line which passes through the centroid of that rod and which is perpendicular to the conductive surface 120a.

At the root of each third rod 124C, a sloped surface is provided which inclines, toward the bottom, outwardly from the center of the axis of the third rod 124C.

Each ridge-side rod 124A has a shape which resembles a quadrangular prism, with its corners being chamfered to a lesser extent, into a curved surface, than are the corners of each third rod 124C. Note that chamfering is optional, and may be omitted.

Regarding the side faces of each ridge-side rod 124A, at least a side face 124d that is opposed to a side face of the ridge 122A, 122B has a right angle, or an angle close to a right angle, with respect to the conductive surface 120a of the second conductive member 120. At the root of any side face of each ridge-side rod 124A that is not opposed to the side face of the ridge 122A, 122B, a sloped surface is provided which inclines, toward the bottom, outwardly from the center of the axis of the ridge-side rod 124A. An “angle which is close to a right angle” means an angle which is closer to a right angle than is the angle between the conductive surface 120a and the side face of at least a rod 124C that is adjacent to the ridge-side rod 124A.

Usually, antenna design is easier without a sloped surface being provided on the rods 124. On the other hand, impedance matching is easier to achieve when the rods 124 have a sloped surface. Therefore, in order to promptly design the antenna while achieving impedance matching, in the present example embodiment, among the side faces of each rod 124, those side faces which are not opposed to the side face of the ridge 122A, 122B are sloped. Furthermore, recesses are made in the ridges 122A and 122B for assisting in impedance matching.

The fact that a sloped surface being provided on the rods 124 improves the degree of impedance matching is disclosed in the specification of U.S. Pat. No. 10,027,032. The entire disclosure of the specification of U.S. Pat. No. 10,027,032 is incorporated herein by reference.

A plurality of rods surround the second through hole 123. Also, a plurality of rods surround each port 125. These rods are through hole-side rods 124B.

Each through hole-side rod 124B has a shape resembling a quadrangular prism, and has its corners chamfered to a greater extent, into a curved surface, than are the corners of each third rod 124C. Note that chamfering of the corners is optional, and may be omitted.

Regarding the side faces of each through hole-side rod 124B, at least a side face 124d of the through hole-side rod 124B that is opposed to the through hole has a right angle, or an angle close to a right angle, with respect to the conductive surface 120a of the second conductive member 120. At the root of any side face of the through hole-side rod 124B that is not opposed to the through hole, a sloped surface is provided which inclines, toward the bottom, outwardly from the center of the axis of the through hole-side rod 124B.

FIG. 12 is a plan view showing the third conductive member 130 as viewed from the front side. On the third conductive member 130, the plurality of ridges 132, and a plurality of electrically-conductive rods 134 surrounding the ridges 132 are disposed. The plurality of rods 134 on the third conductive member 130 similarly include ridge-side rods (first rods) which are disposed along the side faces of the ridges 132 at positions near the ridges, as well as other rods (third rods). These rods are arranged in a two-dimensional array on the conductive surface 130a of the third conductive member 130, along the X and Y directions.

Next, a variant of the present example embodiment will be described.

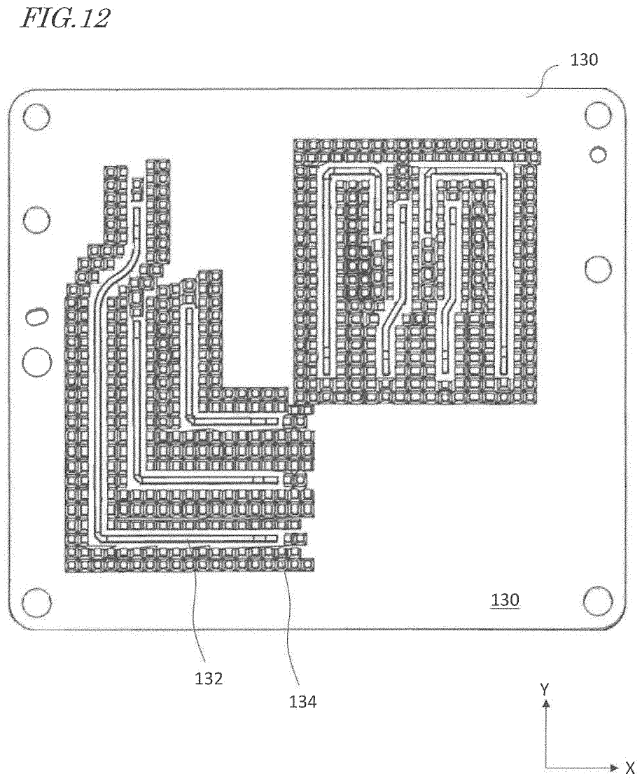

FIG. 13 is a diagram showing a variant of FIG. 7. In this example, a waveguiding wall 160 having stepped portions 162 is located on the second conductive member 120 side. In other words, the waveguiding wall 160 surrounds the second through hole 123, so as to be connected to the conductive surface 120a of the second conductive member 120, which is opposed to the conductive surface 110b of the first conductive member 110. The waveguiding wall 160 may be composed integrally with the second conductive member 120, or be a separate member which is independent from the second conductive member 120. The construction of the waveguiding wall 160 is similar to the construction of the aforementioned waveguiding wall 160. Regarding the inner wall surface of the conductive wall 118 which is parallel to the E plane (the YZ plane), the stepped portions 162 are provided at an edge by which the first conductive member 110 is located. Slopes may be provided instead of the stepped portions 162.

The waveguiding wall 160 may surround at least a part of the space between the first through hole 113A and the second through hole 123, without having to entirely surround this space. With such construction, the waveguiding wall 160 allows an electromagnetic wave to be propagated between the first through hole 113A and the second through hole 123. In FIG. 13, the site corresponding to the waveguiding wall 160 is shown with a different type of hatching from that of the first conductive member 110 and the second conductive member 120; it should be understood that this is for easier visual distinction of the waveguiding wall 160, rather than meaning that the waveguiding wall 160 is a different member from the first conductive member 110 and second conductive member 120.

In the example of FIG. 13, an interspace exists between the end face 165 of the waveguiding wall 160 and the conductive surface 110b of the first conductive member 110. Alternatively, without providing an interspace between the end face 165 of the waveguiding wall 160 and the conductive surface 110b of the first conductive member 110, the end face 165 of the waveguiding wall 160 may be kept in contact with the conductive surface 110b of the first conductive member 110. In that case, too, proper functionality as an antenna is obtained.

### (Exemplary Construction of WRG Waveguide)

Next, a fundamental construction of a waffle-iron ridge waveguide (WRG) that is used in an example embodiment of the present disclosure will be described.

A ridge waveguide which is disclosed in the aforementioned the specification of U.S. Pat. No. 8,779,995, the specification of U.S. Pat. No. 8,803,638, the specification of European Patent Application Publication No. 1331688, the specification of U.S. Pat. No. 10,027,032, the specification of U.S. Patent Publication No. 2018/375219 is provided in a waffle iron structure which is capable of functioning as an artificial magnetic conductor. A ridge waveguide in which such an artificial magnetic conductor is utilized based on the present disclosure is able to realize an antenna feeding network with low losses in the microwave or the millimeter wave band. Moreover, use of such a ridge waveguide allows antenna elements to be disposed with a high density. Such a ridge waveguide may be referred to as a waffle-iron ridge waveguide (WRG) in the present specification. Hereinafter, an exemplary fundamental construction and operation of a waffle-iron ridge waveguide will be described.

An artificial magnetic conductor is a structure which artificially realizes the properties of a perfect magnetic conductor (PMC), which does not exist in nature. One property of a perfect magnetic conductor is that “a magnetic field on its surface has zero tangential component”. This property is the opposite of the property of a perfect electric conductor (PEC), i.e., “an electric field on its surface has zero tangential component”. Although no perfect magnetic conductor exists in nature, it can be embodied by an artificial structure, e.g., an array of a plurality of electrically conductive rods. An artificial magnetic conductor functions as a perfect magnetic conductor in a specific frequency band which is defined by its structure. An artificial magnetic conductor restrains or prevents an electromagnetic wave of any frequency that is contained in the specific frequency band (propagation-restricted band) from propagating along the surface of the artificial magnetic conductor. For this reason, the surface of an artificial magnetic conductor may be referred to as a high impedance surface.

FIG. 14 is a perspective view showing an exemplary fundamental construction of such a waveguide device. FIG. 14 shows XYZ coordinates along X, Y and Z directions which are orthogonal to one another. The waveguide device 100 shown in the figure includes a plate-like (plate-shaped) first electrically conductive member 110 and a plate-like (plate-shaped) second electrically conductive member 120, which are in opposing and parallel positions to each other. A plurality of electrically conductive rods 124 are arrayed on the second conductive member 120.

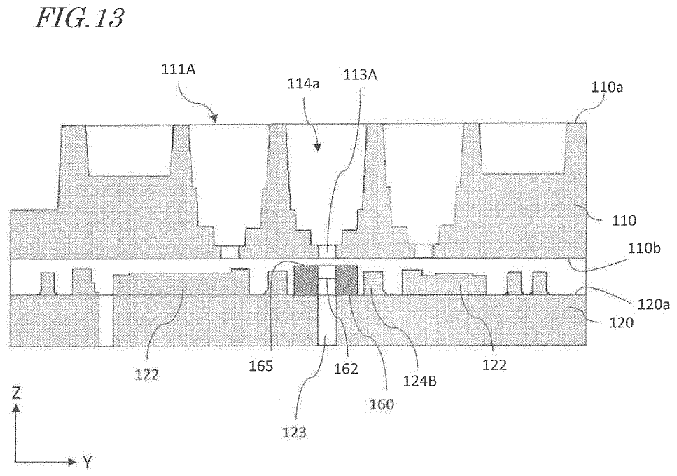

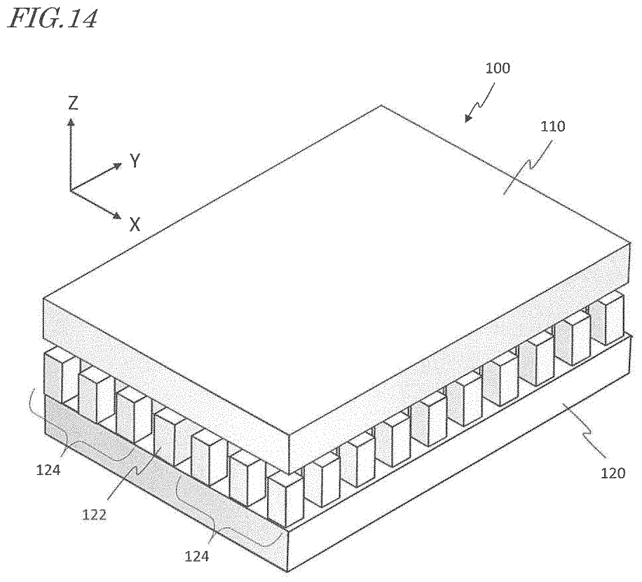

FIG. 15A is a diagram schematically showing a cross-sectional construction of the waveguide device 100 as taken parallel to the XZ plane. As shown in FIG. 15A, the first conductive member 110 has an electrically conductive surface 110b on the side facing the second conductive member 120. The conductive surface 110b has a two-dimensional expanse along a plane which is orthogonal to the axial direction (i.e., the Z direction) of the conductive rods 124 (i.e., a plane which is parallel to the XY plane). Although the conductive surface 110b is shown to be a smooth plane in this example, the conductive surface 110b does not need to be a plane, as will be described later.

FIG. 16 is a perspective view schematically showing the waveguide device 100, illustrated so that the spacing between the first conductive member 110 and the second conductive member 120 is exaggerated for ease of understanding. In an actual waveguide device 100, as shown in FIG. 14 and FIG. 15A, the spacing between the first conductive member 110 and the second conductive member 120 is narrow, with the first conductive member 110 covering over all of the conductive rods 124 on the second conductive member 120.

FIG. 14 to FIG. 16 only show portions of the waveguide device 100. The conductive members 110 and 120, the waveguide member 122, and the plurality of conductive rods 124 actually extend to outside of the portions illustrated in the figures. At an end of the waveguide member 122, a choke structure for preventing electromagnetic waves from leaking into the external space is provided. The choke structure may include a row of conductive rods that are adjacent to the end of the waveguide member 122, for example.

See FIG. 15A again. The plurality of conductive rods 124 arrayed on the second conductive member 120 each have a leading end 124a opposing the conductive surface 110b. In the example shown in the figure, the leading ends 124a of the plurality of conductive rods 124 are on the same plane. This plane defines the surface 126 of an artificial magnetic conductor. Each conductive rod 124 does not need to be entirely electrically conductive, so long as at least the surface (the upper face and the side faces) of the rod-like structure) is electrically conductive. Moreover, each second conductive member 120 does not need to be entirely electrically conductive, so long as it can support the plurality of conductive rods 124 to constitute an artificial magnetic conductor. Of the surfaces of the second conductive member 120, a face carrying the plurality of conductive rods 124 may be electrically conductive, such that the electrical conductor electrically interconnects the surfaces of adjacent ones of the plurality of conductive rods 124. In other words, the entire combination of the second conductive member 120 and the plurality of conductive rods 124 may at least include an electrically conductive surface with rises and falls opposing the conductive surface 110b of the first conductive member 110.

On the second conductive member 120, a ridge-like waveguide member 122 is provided among the plurality of conductive rods 124. More specifically, stretches of an artificial magnetic conductor are present on both sides of the waveguide member 122, such that the waveguide member 122 is sandwiched between the stretches of artificial magnetic conductor on both sides. As can be seen from FIG. 16, the waveguide member 122 in this example is supported on the second conductive member 120, and extends linearly along the Y direction. In the example shown in the figure, the waveguide member 122 has the same height and width as those of the conductive rods 124. As will be described later, however, the height and width of the waveguide member 122 may have respectively different values from those of the conductive rod 124. Unlike the conductive rods 124, the waveguide member 122 extends along a direction (which in this example is the Y direction) in which to guide electromagnetic waves along the conductive surface 110b. Similarly, the waveguide member 122 does not need to be entirely electrically conductive, but may at least include an electrically conductive waveguide face 122a opposing the conductive surface 110b of the first conductive member 110. The second conductive member 120, the plurality of conductive rods 124, and the waveguide member 122 may be portions of a continuous single-piece body. Furthermore, the first conductive member 110 may also be a portion of such a single-piece body.

On both sides of the waveguide member 122, the space between the surface 126 of each stretch of artificial magnetic conductor and the conductive surface 110b of the first conductive member 110 does not allow an electromagnetic wave of any frequency that is within a specific frequency band to propagate. This frequency band is called a “prohibited band”. The artificial magnetic conductor is designed so that the frequency of a signal wave to propagate in the waveguide device 100 (which may hereinafter be referred to as the “operating frequency”) is contained in the prohibited band. The prohibited band may be adjusted based on the following: the height of the conductive rods 124, i.e., the depth of each groove formed between adjacent conductive rods 124; the diameter of each conductive rod 124; the interval between conductive rods 124; and the size of the gap between the leading end 124a and the conductive surface 110b of each conductive rod 124.

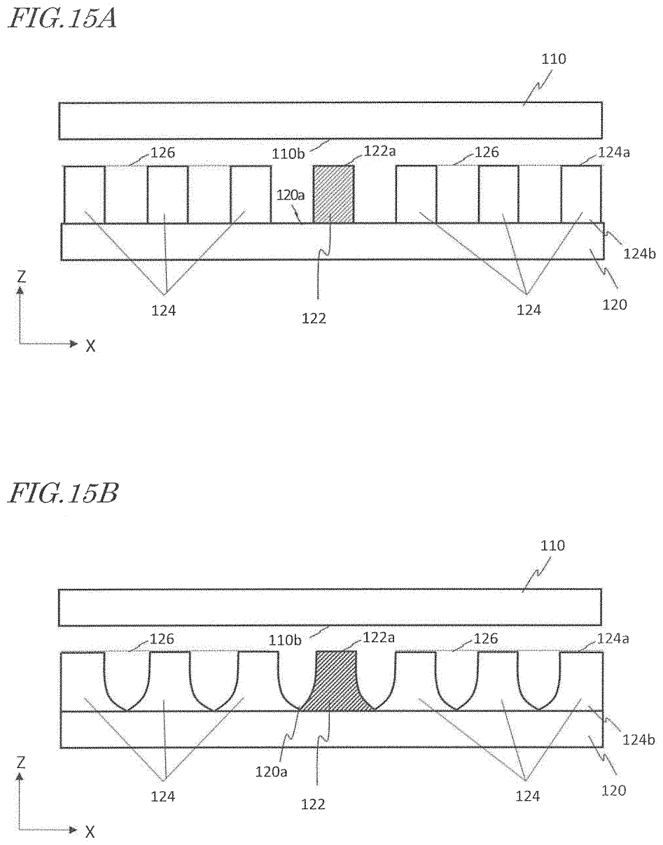

Next, with reference to FIG. 17, the dimensions, shape, positioning, and the like of each member will be described.

FIG. 17 is a diagram showing an exemplary range of dimension of each member in the structure shown in FIG. 15A. The waveguide device is used for at least one of transmission and reception of electromagnetic waves of a predetermined band (referred to as the “operating frequency band”). In the present specification, λo denotes a representative value of wavelengths in free space (e.g., a central wavelength corresponding to a center frequency in the operating frequency band) of an electromagnetic wave (signal wave) propagating in a waveguide extending between the conductive surface 110b of the first conductive member 110 and the waveguide face 122a of the waveguide member 122. Moreover, Am denotes a wavelength, in free space, of an electromagnetic wave of the highest frequency in the operating frequency band. The end of each conductive rod 124 that is in contact with the second conductive member 120 is referred to as the “root”. As shown in FIG. 17, each conductive rod 124 has the leading end 124a and the root 124b. Examples of dimensions, shapes, positioning, and the like of the respective members are as follows.

### (1) Width of the Conductive Rod

The width (i.e., the size along the X direction and the Y direction) of the conductive rod 124 may be set to less than λm/2. Within this range, resonance of the lowest order can be prevented from occurring along the X direction and the Y direction. Since resonance may possibly occur not only in the X and Y directions but also in any diagonal direction in an X-Y cross section, the diagonal length of an X-Y cross section of the conductive rod 124 is also preferably less than λm/2. The lower limit values for the rod width and diagonal length will conform to the minimum lengths that are producible under the given manufacturing method, but is not particularly limited.

### (2) Distance From the Root of the Conductive Rod to the Conductive Surface of the First Conductive Member 110

The distance from the root 124b of each conductive rod 124 to the conductive surface 110b of the first conductive member 110 may be longer than the height of the conductive rods 124, while also being less than λm/2. When the distance is λm/2 or more, resonance may occur between the root 124b of each conductive rod 124 and the conductive surface 110b, thus reducing the effect of signal wave containment.

The distance from the root 124b of each conductive rod 124 to the conductive surface 110b of the first conductive member 110 corresponds to the spacing between the first conductive member 110 and the second conductive member 120. For example, when a signal wave of 76.5±0.5 GHz (which belongs to the millimeter band or the extremely high frequency band) propagates in the waveguide, the wavelength of the signal wave is in the range from 3.8934 mm to 3.9446 mm. Therefore, Am equals 3.8934 mm in this case, so that the spacing between the first conductive member 110 and the second conductive member 120 may be less than a half of 3.8934 mm. So long as the first conductive member 110 and the second conductive member 120 realize such a narrow spacing while being disposed opposite from each other, the first conductive member 110 and the second conductive member 120 do not need to be strictly parallel. Moreover, when the spacing between the first conductive member 110 and the second conductive member 120 is less than λm/2, a whole or a part of the first conductive member 110 and/or the second conductive member 120 may be shaped as a curved surface. On the other hand, the conductive members 110 and 120 each have a planar shape (i.e., the shape of their region as perpendicularly projected onto the XY plane) and a planar size (i.e., the size of their region as perpendicularly projected onto the XY plane) which may be arbitrarily designed depending on the purpose.

Although the conductive surface 120a is illustrated as a plane in the example shown in FIG. 15A, example embodiments of the present disclosure are not limited thereto. For example, as shown in FIG. 15B, the conductive surface 120a may be the bottom parts of faces each of which has a cross section similar to a U-shape or a V-shape. The conductive surface 120a will have such a structure when each conductive rod 124 or the waveguide member 122 is shaped with a width which increases toward the root. In this example, the waveguide member 122 and each the plurality of conductive rods 124 have slanted side faces at their root. The angle of inclination of the waveguide member 122 and each conductive rod 124 at the top of their side faces is smaller than the angle of inclination at their root. Even with such a structure, the device shown in FIG. 15B can function as the waveguide device according to an example embodiment of the present disclosure so long as the distance between the conductive surface 110b and the conductive surface 120a is less than a half of the wavelength λm.

### (3) Distance L2 From the Leading End of the Conductive Rod to the Conductive Surface

The distance L2 from the leading end 124a of each conductive rod 124 to the conductive surface 110b is set to less than λm/2. When the distance is λm/2 or more, a propagation mode where electromagnetic waves reciprocate between the leading end 124a of each conductive rod 124 and the conductive surface 110b may occur, thus no longer being able to contain an electromagnetic wave. Note that, among the plurality of conductive rods 124, at least those which are adjacent to the waveguide member 122 do not have their leading ends in electrical contact with the conductive surface 110b. As used herein, the leading end of a conductive rod not being in electrical contact with the conductive surface means either of the following states: there being an air gap between the leading end and the conductive surface; or the leading end of the conductive rod and the conductive surface adjoining each other via an insulating layer which may exist in the leading end of the conductive rod or in the conductive surface.

### (4) Arrangement and Shape of Conductive Rods

The interspace between two adjacent conductive rods 124 among the plurality of conductive rods 124 has a width of less than λm/2, for example. The width of the interspace between any two adjacent conductive rods 124 is defined by the shortest distance from the surface (side face) of one of the two conductive rods 124 to the surface (side face) of the other. This width of the interspace between rods is to be determined so that resonance of the lowest order will not occur in the regions between rods. The conditions under which resonance will occur are determined based by a combination of: the height of the conductive rods 124; the distance between any two adjacent conductive rods; and the capacitance of the air gap between the leading end 124a of each conductive rod 124 and the conductive surface 110b. Therefore, the width of the interspace between rods may be appropriately determined depending on other design parameters. Although there is no clear lower limit to the width of the interspace between rods, for manufacturing ease, it may be e.g. λm/16 or more when an electromagnetic wave in the extremely high frequency range is to be propagated. Note that the interspace does not need to have a constant width. So long as it remains less than λm/2, the interspace between conductive rods 124 may vary.

The arrangement of the plurality of conductive rods 124 is not limited to the illustrated example, so long as it exhibits a function of an artificial magnetic conductor. The plurality of conductive rods 124 do not need to be arranged in orthogonal rows and columns; the rows and columns may be intersecting at angles other than 90 degrees. The plurality of conductive rods 124 do not need to form a linear array along rows or columns, but may be in a dispersed arrangement which does not present any straightforward regularity. The conductive rods 124 may also vary in shape and size depending on the position on the second conductive member 120.

The surface 126 of the artificial magnetic conductor that are constituted by the leading ends 124a of the plurality of conductive rods 124 does not need to be a strict plane, but may be a plane with minute rises and falls, or even a curved surface. In other words, the conductive rods 124 do not need to be of uniform height, but rather the conductive rods 124 may be diverse so long as the array of conductive rods 124 is able to function as an artificial magnetic conductor.

Each conductive rod 124 does not need to have a prismatic shape as shown in the figure, but may have a cylindrical shape, for example. Furthermore, each conductive rod 124 does not need to have a simple columnar shape. The artificial magnetic conductor may also be realized by any structure other than an array of conductive rods 124, and various artificial magnetic conductors are applicable to the waveguide device of the present disclosure. Note that, when the leading end 124a of each conductive rod 124 has a prismatic shape, its diagonal length is preferably less than λm/2. When the leading end 124a of each conductive rod 124 is shaped as an ellipse, the length of its major axis is preferably less than λm/2. Even when the leading end 124a has any other shape, the dimension across it is preferably less than λm/2 even at the longest position.

The height of each conductive rod 124 (in particular, those conductive rods 124 which are adjacent to the waveguide member 122), i.e., the length from the root 124b to the leading end 124a, may be set to a value which is shorter than the distance (i.e., less than λm/2) between the conductive surface 110b and the conductive surface 120a, e.g., λo/4.

### (5) Width of the Waveguide Face

The width of the waveguide face 122a of the waveguide member 122, i.e., the size of the waveguide face 122a along a direction which is orthogonal to the direction that the waveguide member 122 extends, may be set to less than λm/2 (e.g. λo/8). If the width of the waveguide face 122a is λm/2 or more, resonance will occur along the width direction, which will prevent any WRG from operating as a simple transmission line.

### (6) Height of the Waveguide Member

The height (i.e., the size along the Z direction in the example shown in the figure) of the waveguide member 122 is set to less than λm/2. The reason is that, if the distance is λm/2 or more, the distance between the root 124b of each conductive rod 124 and the conductive surface 110b will be λm/2 or more. Similarly, the height of each conductive rod 124 (in particular, those conductive rods 124 which are adjacent to the waveguide member 122) is also set to less than λm/2.

### (7) Distance L1 Between the Waveguide Face and the Conductive Surface

The distance L1 between the waveguide face 122a of the waveguide member 122 and the conductive surface 110b is set to less than λm/2. If the distance is λm/2 or more, resonance will occur between the waveguide face 122a and the conductive surface 110b, which will prevent functionality as a waveguide. In one example, the distance is λm/4 or less. In order to ensure manufacturing ease, when an electromagnetic wave in the extremely high frequency range is to propagate, the distance is preferably λm/16 or more, for example.

The lower limit of the distance L1 between the conductive surface 110b and the waveguide face 122a and the lower limit of the distance L2 between the conductive surface 110b and the leading end 124a of each conductive rod 124 depends on the machining precision, and also on the precision when assembling the two upper/lower conductive members 110 and 120 so as to be apart by a constant distance. When a pressing technique or an injection technique is used, the practical lower limit of the aforementioned distance is about 50 micrometers (μm). In the case of using an MEMS (Micro-Electro-Mechanical System) to make a product in e.g. the terahertz range, the lower limit of the aforementioned distance is about 2 to about 3 μm.

Next, variants of waveguide structures including the waveguide member 122, the conductive members 110 and 120, and the plurality of conductive rods 124 will be described. The following variants are applicable to the WRG structure in any place in example embodiments of the present disclosure.

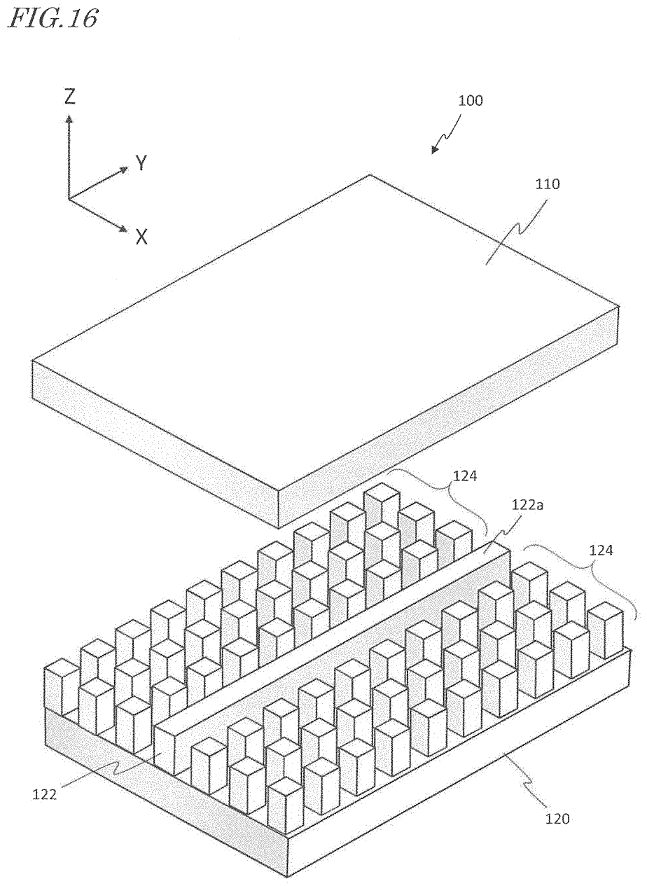

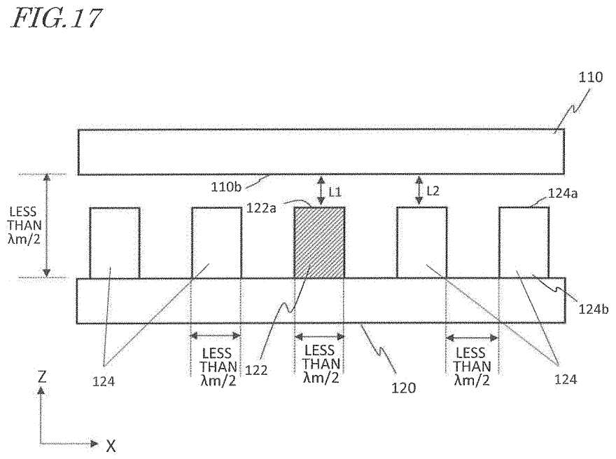

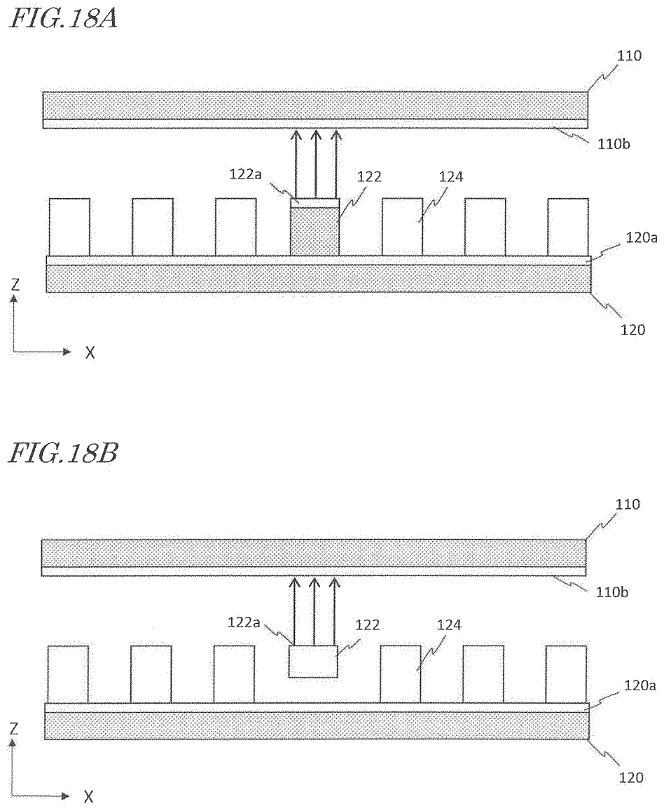

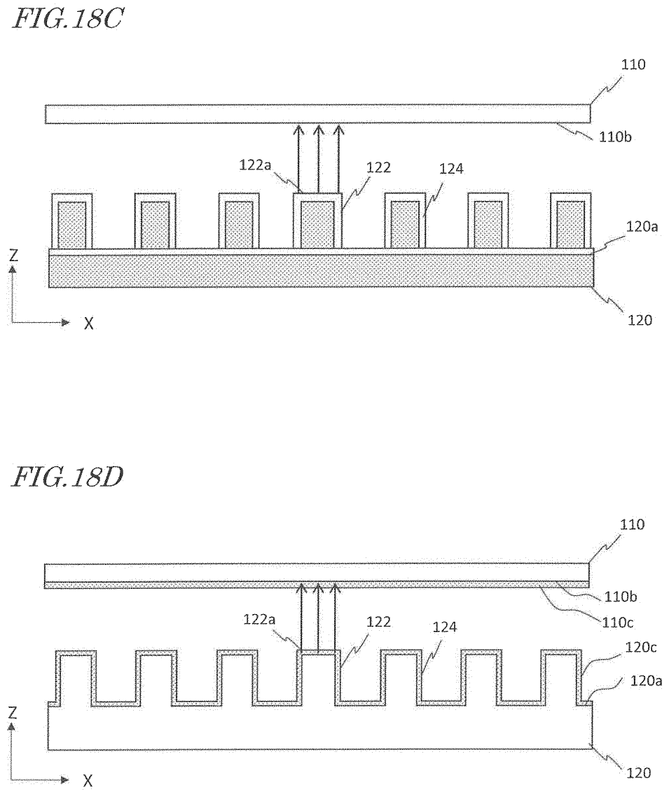

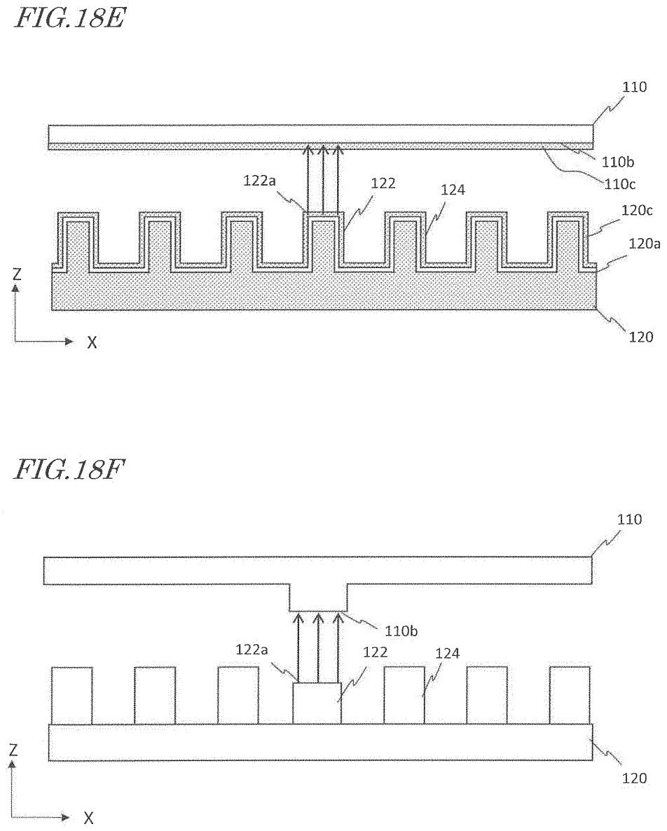

FIG. 18A is a cross-sectional view showing an exemplary structure in which only the waveguide face 122a, defining an upper face of the waveguide member 122, is electrically conductive, while any portion of the waveguide member 122 other than the waveguide face 122a is not electrically conductive. Both of the conductive member 110 and the conductive member 120 alike are only electrically conductive at their surface that has the waveguide member 122 provided thereon (i.e., the conductive surface 110b, 120a), while not being electrically conductive in any other portions. Thus, each of the waveguide member 122, the conductive member 110, and the conductive member 120 does not need to be electrically conductive.

FIG. 18B is a diagram showing a variant in which the waveguide member 122 is not formed on the conductive member 120. In this example, the waveguide member 122 is fixed to a supporting member (e.g., the inner wall of the housing) that supports the conductive members 110 and 120. A gap exists between the waveguide member 122 and the conductive member 120. Thus, the waveguide member 122 does not need to be connected to the conductive member 120.

FIG. 18C is a diagram showing an exemplary structure where the conductive member 120, the waveguide member 122, and each of the plurality of conductive rods 124 are composed of a dielectric surface that is coated with an electrically conductive material such as a metal. The conductive member 120, the waveguide member 122, and the plurality of conductive rods 124 are connected to one another via the electrical conductor. On the other hand, the conductive member 110 is made of an electrically conductive material such as a metal.

FIG. 18D and FIG. 18E are diagrams each showing an exemplary structure in which dielectric layers 110c and 120c are respectively provided on the outermost surfaces of conductive members 110 and 120, a waveguide member 122, and conductive rods 124. FIG. 18D shows an exemplary structure in which the surface of metal conductive members, which are electrical conductors, are covered with a dielectric layer. FIG. 18E shows an example where the conductive member 120 is structured so that the surface of members which are composed of a dielectric, e.g., resin, is covered with an electrical conductor such as a metal, this metal layer being further coated with a dielectric layer. The dielectric layer that covers the metal surface may be a coating of resin or the like, or an oxide film of passivation coating or the like which is generated as the metal becomes oxidized.

The dielectric layer on the outermost surface will allow losses to be increased in the electromagnetic wave propagating through the WRG waveguide, but is able to protect the conductive surfaces 110b and 120a (which are electrically conductive) from corrosion. It also prevents influences of a DC voltage, or an AC voltage of such a low frequency that it is not capable of propagation on certain WRG waveguides.

FIG. 18F is a diagram showing an example where the height of the waveguide member 122 is lower than the height of the conductive rods 124, and the portion of the conductive surface 110b of the conductive member 110 that is opposed to the waveguide face 122a protrudes toward the waveguide member 122. Even such a structure will operate in a similar manner to the above-described construction, so long as the ranges of dimensions depicted in FIG. 17 are satisfied.

FIG. 18G is a diagram showing an example where, further in the structure of FIG. 18F, portions of the conductive surface 110b that are opposed to the conductive rods 124 protrude toward the conductive rods 124. Even such a structure will operate in a similar manner to the above-described example, so long as the ranges of dimensions depicted in FIG. 17 are satisfied. Instead of a structure in which the conductive surface 110b partially protrudes, a structure in which the conductive surface 110b is partially dented may be adopted.

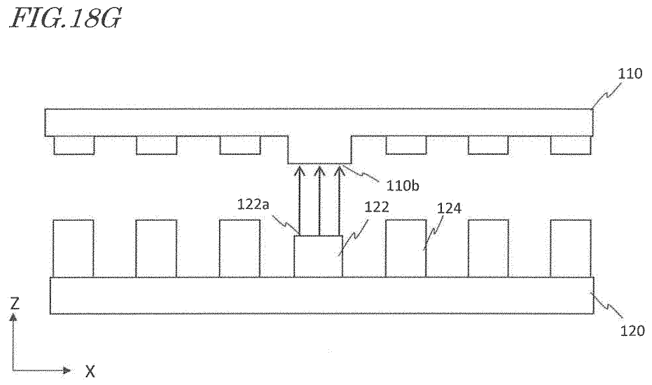

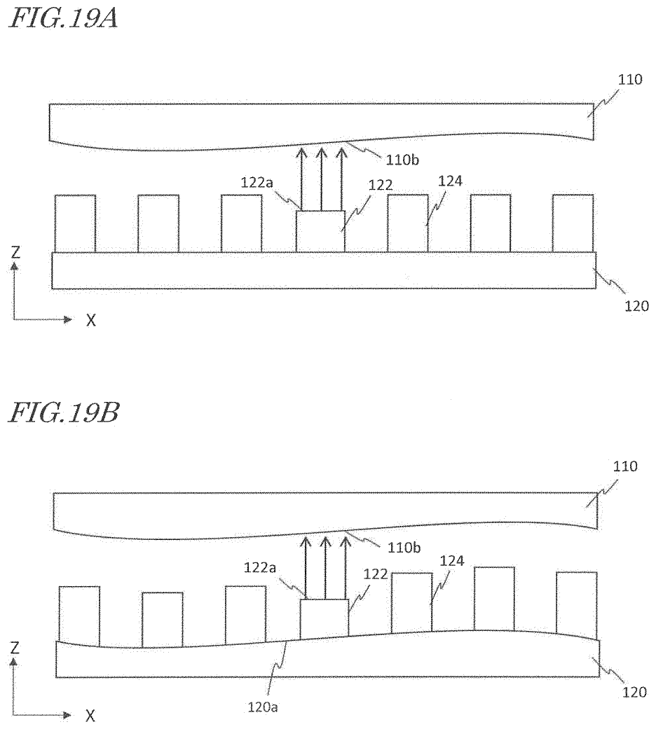

FIG. 19A is a diagram showing an example where a conductive surface 110b of the conductive member 110 is shaped as a curved surface. FIG. 19B is a diagram showing an example where also a conductive surface 120a of the conductive member 120 is shaped as a curved surface. As demonstrated by these examples, the conductive surfaces 110b and 120a may not be shaped as planes, but may be shaped as curved surfaces. A conductive member having a conductive surface which is a curved surface is also qualifies as a conductive member having a “plate shape”.

In the waveguide device 100 of the above-described construction, a signal wave of the operating frequency is unable to propagate in the space between the surface 126 of the artificial magnetic conductor and the conductive surface 110b of the conductive member 110, but propagates in the space between the waveguide face 122a of the waveguide member 122 and the conductive surface 110b of the conductive member 110. Unlike in a hollow waveguide, the width of the waveguide member 122 in such a waveguide structure does not need to be equal to or greater than a half of the wavelength of the electromagnetic wave to propagate. Moreover, the conductive member 110 and the conductive member 120 do not need to be electrically interconnected by a metal wall that extends along the thickness direction (i.e., in parallel to the YZ plane).

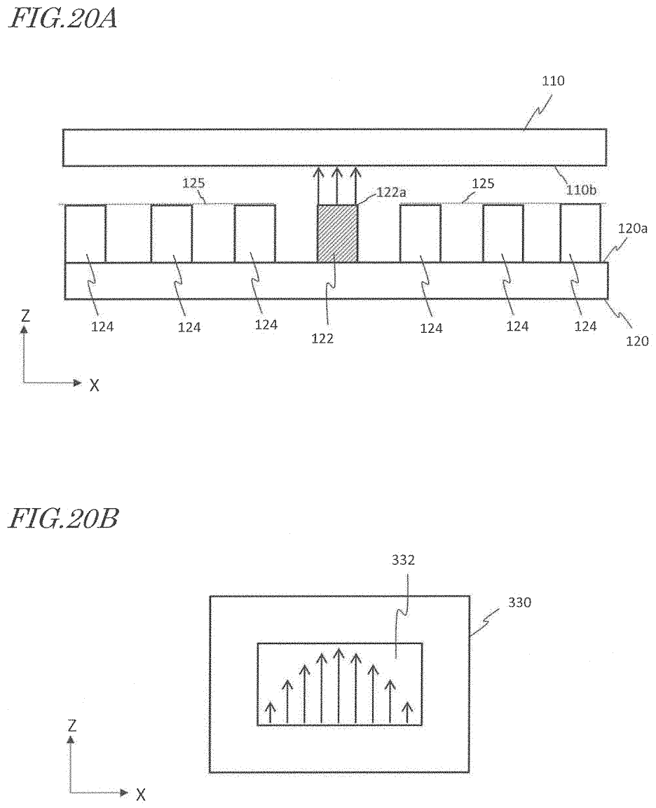

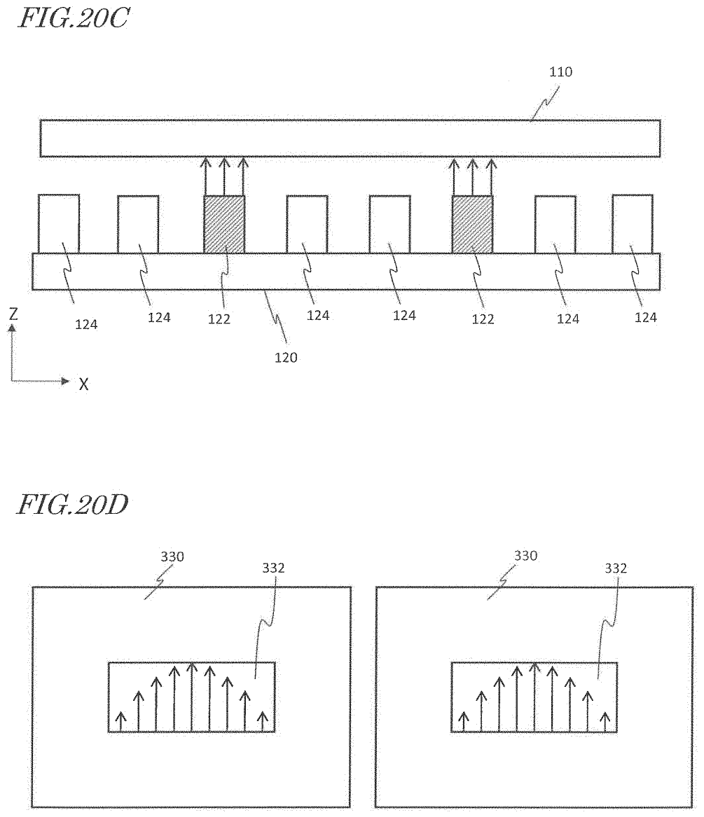

FIG. 20A schematically shows an electromagnetic wave that propagates in a narrow space, i.e., a gap between the waveguide face 122a of the waveguide member 122 and the conductive surface 110b of the conductive member 110. Three arrows in FIG. 20A schematically indicate the orientation of an electric field of the propagating electromagnetic wave. The electric field of the propagating electromagnetic wave is perpendicular to the conductive surface 110b of the conductive member 110 and to the waveguide face 122a.

On both sides of the waveguide member 122, stretches of artificial magnetic conductor that are created by the plurality of conductive rods 124 are present. An electromagnetic wave propagates in the gap between the waveguide face 122a of the waveguide member 122 and the conductive surface 110b of the conductive member 110. FIG. 20A is schematic, and does not accurately represent the magnitude of an electromagnetic field to be actually created by the electromagnetic wave. A part of the electromagnetic wave (electromagnetic field) propagating in the space over the waveguide face 122a may have a lateral expanse, to the outside (i.e., toward where the artificial magnetic conductor exists) of the space that is delineated by the width of the waveguide face 122a. In this example, the electromagnetic wave propagates in a direction (i.e., the Y direction) which is perpendicular to the plane of FIG. 20A. As such, the waveguide member 122 does not need to extend linearly along the Y direction, but may include a bend(s) and/or a branching portion(s) not shown. Since the electromagnetic wave propagates along the waveguide face 122a of the waveguide member 122, the direction of propagation would change at a bend, whereas the direction of propagation would ramify into plural directions at a branching portion.

In the waveguide structure of FIG. 20A, no metal wall (electric wall), which would be indispensable to a hollow waveguide, exists on both sides of the propagating electromagnetic wave. Therefore, in the waveguide structure of this example, “a constraint due to a metal wall (electric wall)” is not included in the boundary conditions for the electromagnetic field mode to be created by the propagating electromagnetic wave, and the width (size along the X direction) of the waveguide face 122a is less than a half of the wavelength of the electromagnetic wave.

For reference, FIG. 20B schematically shows a cross section of a hollow waveguide 330. With arrows, FIG. 20B schematically shows the orientation of an electric field of an electromagnetic field mode (TE₁₀) that is created in the internal space 332 of the hollow waveguide 330. The lengths of the arrows correspond to electric field intensities. The width of the internal space 332 of the hollow waveguide 330 needs to be set to be broader than a half of the wavelength. In other words, the width of the internal space 332 of the hollow waveguide 330 cannot be set to be smaller than a half of the wavelength of the propagating electromagnetic wave.

FIG. 20C is a cross-sectional view showing an implementation where two waveguide members 122 are provided on the conductive member 120. Thus, an artificial magnetic conductor that is created by the plurality of conductive rods 124 exists between the two adjacent waveguide members 122. More accurately, stretches of artificial magnetic conductor created by the plurality of conductive rods 124 are present on both sides of each waveguide member 122, such that each waveguide member 122 is able to independently propagate an electromagnetic wave.

For reference's sake, FIG. 20D schematically shows a cross section of a waveguide device in which two hollow waveguides 330 are placed side-by-side. The two hollow waveguides 330 are electrically insulated from each other. Each space in which an electromagnetic wave is to propagate needs to be surrounded by a metal wall that defines the respective hollow waveguide 330. Therefore, the interval between the internal spaces 332 in which electromagnetic waves are to propagate cannot be made smaller than a total of the thicknesses of two metal walls. Usually, a total of the thicknesses of two metal walls is longer than a half of the wavelength of a propagating electromagnetic wave. Therefore, it is difficult for the interval between the hollow waveguides 330 (i.e., interval between their centers) to be shorter than the wavelength of a propagating electromagnetic wave. Particularly for electromagnetic waves of wavelengths in the extremely high frequency range (i.e., electromagnetic wave wavelength: 10 mm or less) or even shorter wavelengths, a metal wall which is sufficiently thin relative to the wavelength is difficult to be formed. This presents a cost problem in commercially practical implementation.

On the other hand, a waveguide device 100 including an artificial magnetic conductor can easily realize a structure in which waveguide members 122 are placed close to one another. Thus, such a waveguide device 100 can be suitably used in an array antenna that includes plural antenna elements in a close arrangement.

Next, an exemplary construction for a slot antenna utilizing the aforementioned waveguide structure will be described. A “slot antenna” means an antenna device having one or plural slots (also referred to as “through holes”) as antenna elements. In particular, a slot antenna having a plurality of slots as antenna elements will be referred to as a “slot array antenna” or a “slot antenna array”.

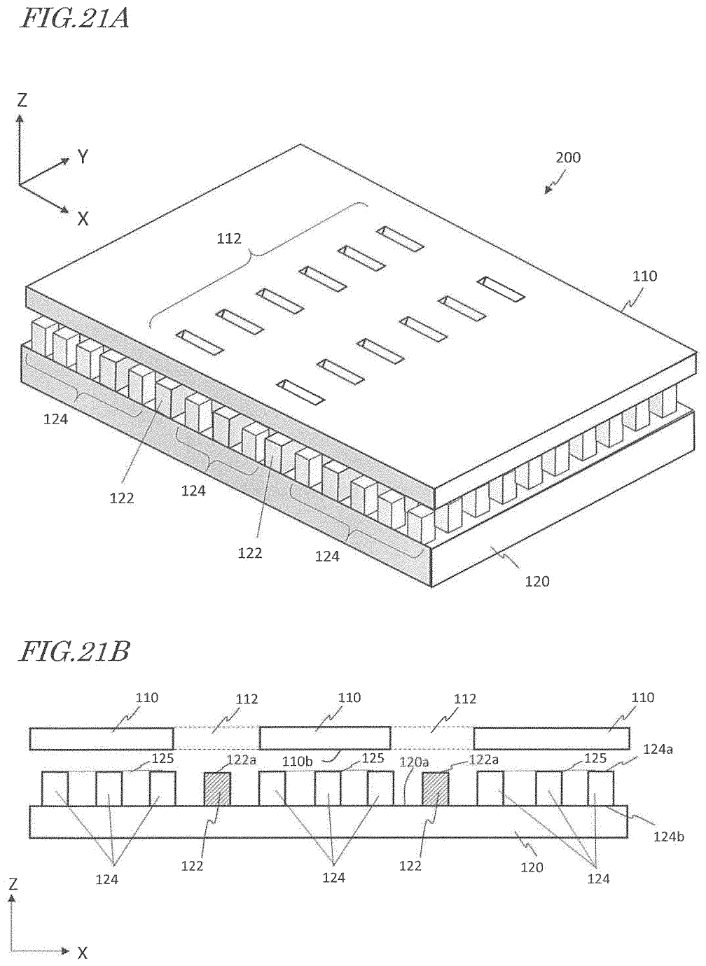

FIG. 21A is a perspective view schematically showing a portion of the construction of an antenna device 200 utilizing the aforementioned waveguide structure. FIG. 21B is a diagram showing schematically showing a portion of a cross section taken parallel to an XZ plane which passes through the centers of two adjacent slots 112 along the X direction of the antenna device 200. In the antenna device 200, the first conductive member 110 has a plurality of slots 112 arranged along the X direction and the Y direction. In this example, the plurality of slots 112 include two slot rows, each slot row including six slots 112 arranged at an equal interval along the Y direction. On the second conductive member 120, two waveguide members 122 extending along the Y direction are provided. Each waveguide member 122 has an electrically-conductive waveguide face 122a opposing one slot row. In a region between the two waveguide members 122 and in regions outside of the two waveguide members 122, a plurality of conductive rods 124 are disposed. These conductive rods 124 constitute an artificial magnetic conductor.

From a transmission circuit not shown, an electromagnetic wave is supplied to a waveguide extending between the waveguide face 122a of each waveguide member 122 and the conductive surface 110b of the conductive member 110. Among the plurality of slots 112 arranged along the Y direction, the distance between the centers of two adjacent slots 112 is designed so as to be equal in value to the wavelength of an electromagnetic wave propagating in the waveguide, for example. As a result of this, electromagnetic waves with an equal phase can be radiated from the six slots 112 arranged along the Y direction.

The antenna device 200 shown in FIG. 21A and FIG. 21B is an antenna array device in which the plurality of slots 112 serve as antenna elements (radiating elements). With such construction, the interval between the centers of radiating elements can be made shorter than a wavelength λo in free space of an electromagnetic wave propagating through the waveguide, for example. Horns may be provided for the plurality of slots 112. By providing horns, radiation characteristics or reception characteristics can be improved. As the horns, the horn of each antenna element 111A as has been described with reference to FIG. 1 to FIG. 13 can be used, for example.

Next, an example embodiment of another antenna device that includes a waveguide device and at least one antenna element (radiating element) which is connected to a waveguide inside the waveguiding wall of the waveguide device will be described. To be “connected to a waveguide inside the waveguiding wall” means either being directly connected, or being indirectly connected via another waveguide (e.g., the aforementioned WRG), to the waveguide inside the waveguiding wall. The at least one antenna element has at least one of: the function of radiating into space an electromagnetic wave which has propagated through the waveguide inside the waveguiding wall; and the function of allowing an electromagnetic wave which has propagated in space to be introduced into the waveguide inside the waveguiding wall. That is, the antenna device according to the present example embodiment is used for at least one of transmission and reception of signals.

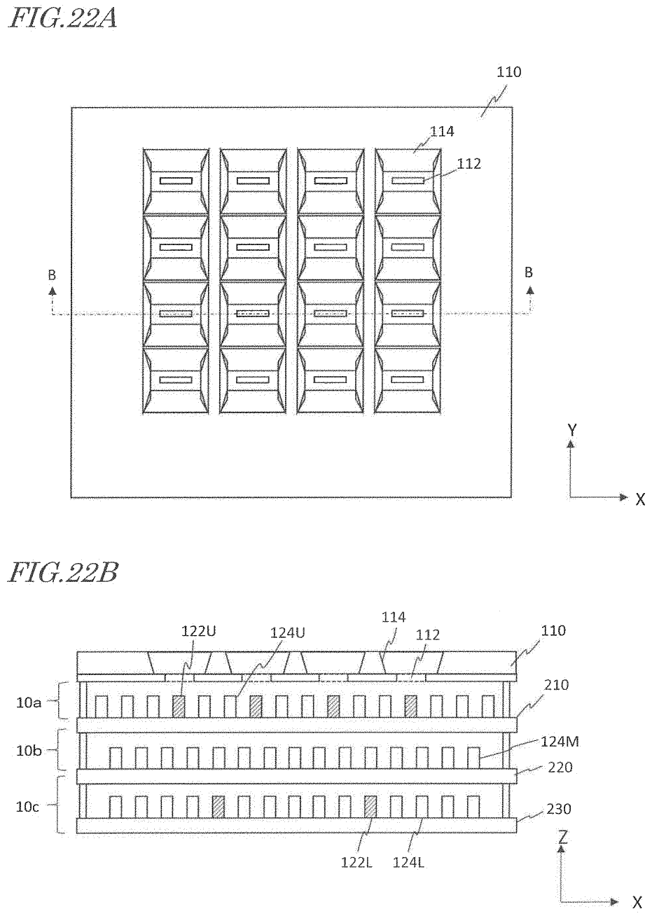

FIG. 22A is a diagram showing an example of an antenna device (antenna array) in which a plurality of slots (apertures) are arrayed. FIG. 22A is an upper plan view showing the antenna device as viewed from the +Z direction. FIG. 22B is a cross-sectional view taken along line B-B in FIG. 22A. In the antenna device shown, the following are layered: a first waveguiding layer 10a including a plurality of waveguide members 122U that directly couple to a plurality of slots 112 functioning as radiating elements; a second waveguiding layer 10b including a plurality of conductive rods 124M and waveguiding walls not shown; and a third waveguiding layer 10c including another waveguide member 122L that couples to the waveguide members 122U of the first waveguiding layer 10a via the waveguiding walls. The plurality of waveguide members 122U and a plurality of conductive rods 124U in the first waveguiding layer 10a are disposed on the first conductive member 210. The plurality of conductive rods 124M and the waveguiding walls not shown in the second waveguiding layer 10b are disposed on the second conductive member 220. The waveguide member 122L and the plurality of conductive rods 124L in the third waveguiding layer 10c are disposed on the third conductive member 230.

This antenna device further includes a conductive member 110 that covers the waveguide members 122U and the conductive rods 124U in the first waveguiding layer 10a. The conductive member 110 has 16 slots (apertures) 112 that are arrayed in four rows and four columns. On the conductive member 110, side walls 114 surrounding each slot 112 are provided. For each slot 112, the side walls 114 constitute a horn for adjusting the directivity of the slot 112. The number and arrangement of slots 112 in this example are only an example. The orientation and shape of each slot 112 are not limited to the example shown. For example, H-shaped slots may be used. Likewise, what is shown in the figures should not be seen as a limitation as to whether the side walls 114 of the horn are sloped or not, angles thereof, or the horn shape. Instead of the horn as illustrated, the horn structure in Example embodiment 1 may be adopted, for example.

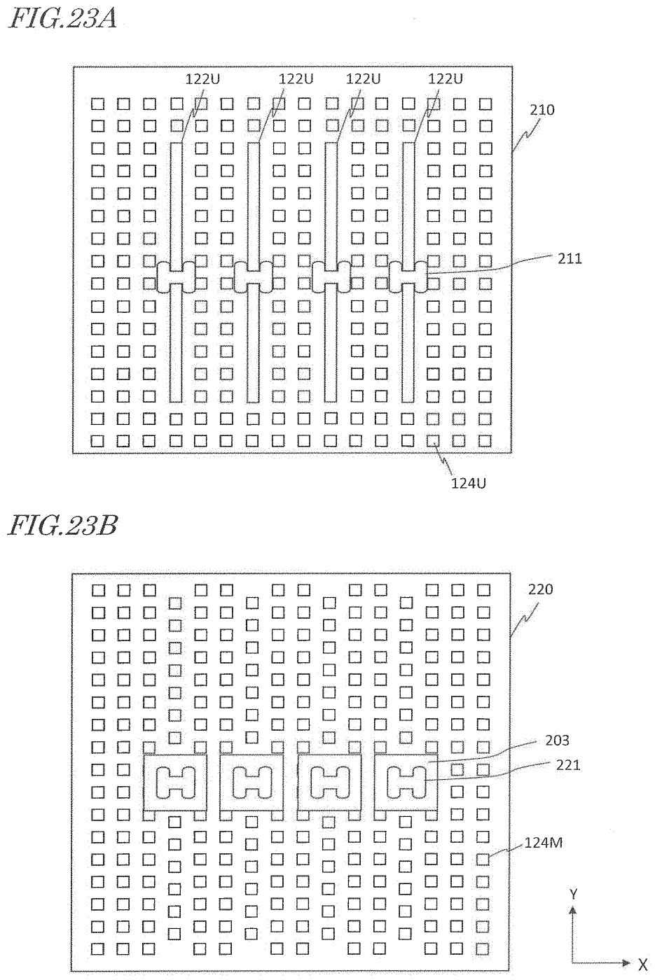

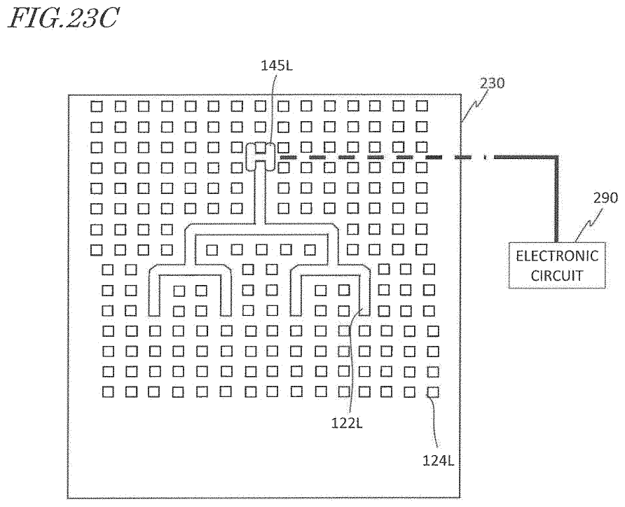

FIG. 23A is a diagram showing a planar layout of the waveguide members 122U and the conductive rods 124U on the first conductive member 210. FIG. 23B is a diagram showing a planar layout of the conductive rods 124M, the waveguiding wall 203, and the through hole 221 on the second conductive member 220. FIG. 23C is a diagram showing a planar layout of the waveguide member 122L and the conductive rods 124L on the third conductive member 230. As is clear from these figures, the waveguide members 122U on the first conductive member 210 extend in linear shapes (stripes), without having any branching portions or bends. On the other hand, the waveguide member 122L on the third conductive member 230 includes both of: branching portions beyond each of which it extends into two split directions; and bends beyond each of which it extends in a different direction. Between each through hole 211 in the first conductive member 210 and each through hole 221 in the second conductive member 220, as shown in FIG. 23B, the waveguiding wall 203 is disposed. Although the waveguiding wall 203 in this example is structured so as to have a rectangular XY-plane cross section, the structure of the waveguiding wall 160 which has been described with reference to FIG. 8 may instead be adopted, for example.

In the example shown in FIG. 23B, four through holes 221 exist in the second conductive member 220. Four pairs of waveguiding walls 203 are disposed so as to each sandwich the central portion of the respective through hole 221. The waveguide members 122U on the first conductive member 210 couple to the waveguide member 122L on the third conductive member 230 via the through holes 211, the waveguiding walls 203, and the through holes 221. In other words, an electromagnetic wave which has propagated along the waveguide member 122L on the third conductive member 230 passes through the through holes 221, the waveguiding walls 203, and the through holes 211 to reach the waveguide members 122U on the first conductive member 210, and propagates along the waveguide members 122U. In this case, each slot 112 functions as an antenna element to allow an electromagnetic wave which has propagated through the waveguide to be radiated into space. Conversely, when an electromagnetic wave which has propagated in space impinges on a slot 112, the electromagnetic wave couples to the waveguide member 122U that lies immediately under that slot 112, and propagates along the waveguide member 122U. An electromagnetic wave which has propagated along a waveguide member 122U may also pass through the through hole 211, the waveguiding wall 203, and the through hole 221 to reach the ridge 122L on the third conductive member 230, and propagate along the ridge 122L.

Via a port (through hole) 145L in the third conductive member 230, the waveguide member 122L may couple to an external waveguide device or radio frequency circuit (electronic circuit). As one example, FIG. 23C illustrates an electronic circuit 290 which is connected to the port 145L. Without being limited to a specific position, the electronic circuit 290 may be provided at any arbitrary position. The electronic circuit 290 may be provided on a circuit board which is on the rear surface side (i.e., the lower side in FIG. 22B) of the third conductive member 230, for example. Such an electronic circuit may include a microwave integrated circuit, e.g. an MMIC (Monolithic Microwave Integrated Circuit) that generates or receives millimeter waves, for example. In addition to the microwave integrated circuit, the electronic circuit 290 may further include another circuit, e.g., a signal processing circuit. Such a signal processing circuit may be configured to execute various processes that are necessary for the operation of a radar system that includes an antenna device, for example. The electronic circuit 290 may include a communication circuit. The communication circuit may be configured to execute various processes that are necessary for the operation of a communication system that includes an antenna device.

Note that a structure for connecting an electronic circuit to a waveguide is disclosed in, for example, U.S. Patent Publication No. 2018/0351261, U.S. Patent Publication No. 2019/0006743, U.S. Patent Publication No. 2019/0139914, U.S. Patent Publication No. 2019/0067780, U.S. Patent Publication No. 2019/0140344, and International Patent Application Publication No. 2018/105513. The entire disclosure of these publications is incorporated herein by reference.

The conductive member 110 shown in FIG. 23A may be called a “radiation layer”. The layer containing the entirety of the waveguide members 122U and the conductive rods 124U on the first conductive member 210 shown in FIG. 23A may be called an “excitation layer”; the layer containing the entirety of the conductive rods 124M and the waveguiding walls 203 on the second conductive member 220 shown in FIG. 23B may be called an “intermediate layer”; and the layer containing the entirety of the waveguide member 122L and the conductive rods 124L on the third conductive member 230 shown in FIG. 23C may be called a “distribution layer”. Moreover, the “excitation layer”, the “intermediate layer”, and the “distribution layer” may be collectively called a “feeding layer”. Each of the “radiation layer”, the “excitation layer”, the “intermediate layer”, and the “distribution layer” can be mass-produced by processing a single metal plate. The radiation layer, the excitation layer, the distribution layer, and any electronic circuitry to be provided on the rear face side of the distribution layer may be produced as a single-module product.

In the antenna array of this example, as can be seen from FIG. 22B, a plate-like radiation layer, excitation layer, and distribution layer are layered, so that, as a whole, a flat panel antenna which is flat and low-profiled is realized. For example, the height (thickness) of a multilayer structure having a cross-sectional construction as shown in FIG. 22B can be made 20 mm or less.

With the waveguide member 122L shown in FIG. 23C, the distances from the port 145L of the third conductive member 230 to the respective through holes 211 (see FIG. 23A) in the first conductive member 210 as measured along the waveguide member 122L are all equal. Therefore, a signal wave which is input from the port 145L of the third conductive member 230 to the waveguide member 122L reaches the four through holes 211 in the first conductive member 210 all in the same phase. As a result, the four waveguide members 122U on the first conductive member 210 can be excited in the same phase.

Note that it is not necessary for all slots 112 functioning as antenna elements to radiate electromagnetic waves in the same phase. The network patterns of the waveguide members 122 in the excitation layer and the distribution layer may be arbitrary, and each waveguide member 122 may be configured to independently propagate a mutually different signal.

Although the waveguide members 122U on the first conductive member 210 according to the present example embodiment lacks branching portions and bends, portions thereof that function as the excitation layer may include at least one of a branching portion(s) and a bend(s). As described earlier, it is not necessary for all conductive rods in the waveguide device to have similar shapes.

According to the present example embodiment, between the through holes 211 in the first conductive member 210 and the through holes 221 in the second conductive member 220, electromagnetic waves can be directly propagated via the electrically-conductive waveguiding walls 203. Since unwanted propagation does not occur on the second conductive member 220, structures such as other waveguides, circuit boards, or a camera may be disposed on the second conductive member 220. Thus, the device enjoys an improved design freedom. Although the present example embodiment illustrates that the waveguiding walls are disposed between the first conductive member 210 and the second conductive member 220, the waveguiding walls may be disposed in other positions.

When constructing an excitation layer and a distribution layer, various circuit elements in waveguides can be utilized. Examples thereof are disclosed in U.S. Pat. No. 10,042,045, U.S. Pat. No. 10,090,600, U.S. Pat. No. 10,158,158, International Patent Application Publication No. 2018/207796, International Patent Application Publication No. 2018/207838, and U.S. Patent Publication No. 2019/0074569, for example. The entire disclosure of these publications is incorporated herein by reference.

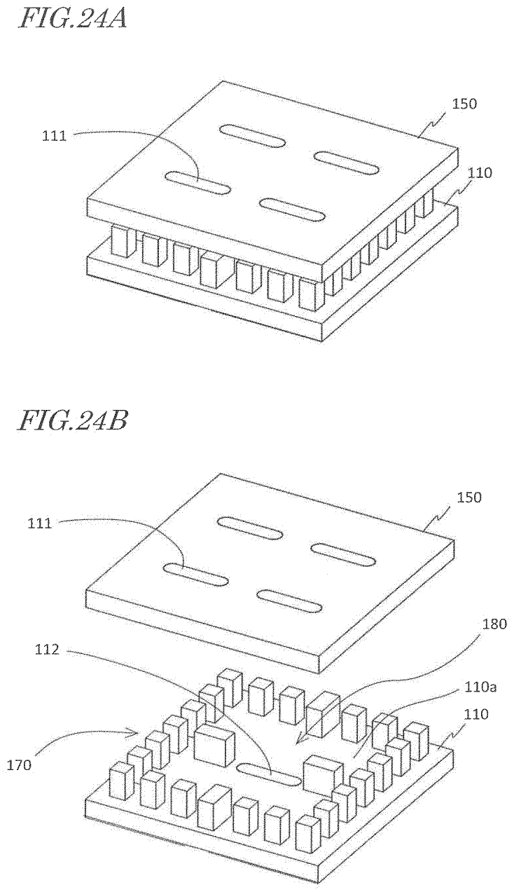

FIG. 24A is a perspective view showing one radiating element of a slot antenna device according to still another variant. The slot antenna device of this example additionally includes the further conductive member 150, which has a conductive surface that is opposed to the conductive surface 110a on the front side of the conductive member 110. In this example, the further conductive member 150 has four further slots 111. FIG. 24B is illustrated so that the spacing between the conductive members 110 and 150 is exaggerated in the radiating element of FIG. 24A.

While each slot 112 in FIG. 22A communicates with a horn 114, the slot 112 in the example shown in FIG. 24A communicates with a cavity 180. The cavity 180 is a flat hollow that is surrounded by the conductive surface 110a, the plurality of conductive rods 170 provided on the front side of the conductive member 110, and a conductive surface on the rear side of the further conductive member 150. In the example shown in FIGS. 24A and 24B, a gap exists between the leading ends of the plurality of conductive rods 170 and the conductive surface on the rear side of the further conductive member 150. The roots of the plurality of conductive rods 170 are connected to the conductive surface 110a of the conductive member 110. A construction may also be adopted where the plurality of conductive rods 170 are connected to the further conductive member 150. In that case, however, a gap is needed between the leading ends of the plurality of rods 170 and the conductive surface 110a.

The further conductive member 150 has four further slots 111, each slot 111 communicating with the cavity 180. A signal wave which is radiated from the slot 112 into the cavity 180 is radiated toward the front side of the further conductive member 150 via the four further slots 111. A structure may also be adopted where a horn is provided on the front side of the further conductive member 150, such that the further slots 111 open at the bottom of that horn. In this case, a signal wave which is radiated from the slot 112 is radiated via the cavity 180, the further slots 111, and the horn.

Next, variants of the shape of each through hole (slot or port) according to example embodiments of the present disclosure will be described. A cross section that is taken perpendicular to the axis of the through hole may have shapes as described in the following, for example. The variants presented below are similarly applicable to any example embodiment of the present disclosure.

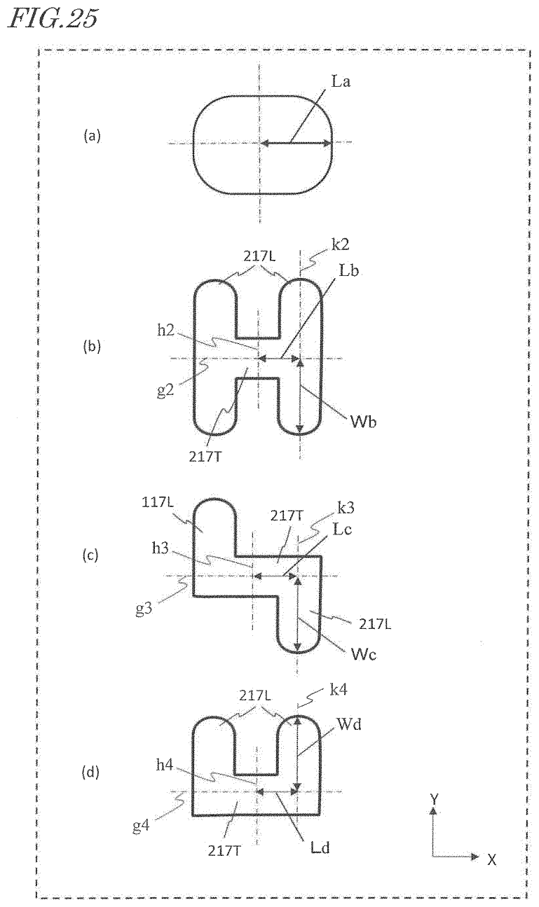

In FIG. 25, (a) shows an exemplary hollow waveguide having the shape of an ellipse. The semimajor axis La of the hollow waveguide indicated by arrowheads in the figure is chosen so that higher-order resonance will not occur and that the impedance will not be too small. More specifically, La may be chosen so that λo/4<La<λo/2, where λo is a wavelength in free space corresponding to the center frequency in the operating frequency band.

In FIG. 25, (b) shows an exemplary hollow waveguide having an H shape that includes a pair of vertical portions 217L and a lateral portion 217T interconnecting the pair of vertical portions 217L. The lateral portion 217T is substantially perpendicular the pair of vertical portions 217L, and connects between the substantial central portions of the pair of vertical portions 217L. Such an H-shape hollow waveguide will also have its shape and size determined so that higher-order resonance will not occur and that the impedance will not be too small. Let the distance from a point of intersection between a center line g2 of the lateral portion 217T and a center line h2 of the overall H shape taken perpendicular to the lateral portion 217T to a point of intersection between the center line g2 and a center line k2 of a vertical portion 217L be Lb. Let the distance from a point of intersection between the center line g2 and the center line k2 to an end of the vertical portion 217L be Wb. Then, a sum of Lb and Wb is chosen so as to satisfy λo/4<Lb+Wb<λo/2. Choosing the distance Wb to be relatively long allows the distance Lb to be relatively short. As a result, the width along the X direction of the H shape can be e.g. less than λo/2, whereby the interval between the lateral portions 217T along the longitudinal direction can be made short.

In FIG. 25, (c) shows an exemplary hollow waveguide that includes a lateral portion 217T and a pair of vertical portions 217L extending from both ends of the lateral portion 217T. The directions in which the pair of vertical portions 217L extend from the lateral portion 217T are substantially perpendicular to the lateral portion 217T, and are opposite to each other. Let the distance from a point of intersection between a center line g3 of the lateral portion 217T and a center line h3 of the overall shape taken perpendicular to the lateral portion 217T and a point of intersection between the center line g3 and a center line k3 of a vertical portion 217L be Lc. Let the distance between a point of intersection between the center line g3 and the center line k3 and the end of the vertical portion 217L be Wc. Then, a sum of Lc and Wc is chosen so as to satisfy λo/4<Lc+Wc<λo/2. Choosing the distance Wc to be relatively long allows the distance Lc to be relatively short. As a result, the width along the X direction of the overall shape of (c) in FIG. 25 can be e.g. less than λo/2, whereby the interval between the lateral portions 217T along the longitudinal direction can be made short.

In FIG. 25, (d) shows an exemplary hollow waveguide that includes a lateral portion 217T and a pair of vertical portions 217L extending from both ends of the lateral portion 217T in an identical direction which is perpendicular to the lateral portion 217T. Such a shape may be referred to as a “U shape” in the present specification. Note that the shape of (d) in FIG. 25 may be regarded as an upper half shape of an H shape. Let the distance from a point of intersection between a center line g4 of the lateral portion 217T and a center line h4 of the overall U shape taken perpendicular to the lateral portion 217T to a point of intersection between the center line g4 and a center line k4 of a vertical portion 217L be Ld. Let the distance from a point of intersection between the center line g4 and the center line k4 and the end of the vertical portion 217L be Wd. Then, a sum of Ld and Wd is chosen so as to satisfy λo/4<Ld+Wd<λo/2. Choosing the distance Wd to be relatively long allows the distance Ld to be relatively short. As a result, the width along the X direction of the U shape can be e.g. less than λo/2, whereby the interval between the lateral portions 217T along the longitudinal direction can be made short.

An antenna device according to an example embodiment of the present disclosure can be suitably used in a radar device or a radar system to be incorporated in moving entities such as vehicles, marine vessels, aircraft, robots, or the like, for example. A radar device would include an antenna device according to an example embodiment of the present disclosure and a microwave integrated circuit that is connected to the antenna device. A radar system would include the radar device and a signal processing circuit that is connected to the microwave integrated circuit of the radar device. The signal processing circuit may perform a process of estimating the azimuth of an arriving wave based on a signal that is received by a microwave integrated circuit, for example. For example, the signal processing circuit may be configured to execute the MUSIC method, the ESPRIT method, the SAGE method, or other algorithms to estimate the azimuth of the arriving wave, and output a signal indicating the estimation result. Furthermore, the signal processing circuit may be configured to estimate the distance to each target as a wave source of an arriving wave, the relative velocity of the target, and the azimuth of the target by using a known algorithm, and output a signal indicating the estimation result.

In the present disclosure, the term “signal processing circuit” is not limited to a single circuit, but encompasses any implementation in which a combination of plural circuits is conceptually regarded as a single functional part. The signal processing circuit may be realized by one or more System-on-Chips (SoC). For example, a part or a whole of the signal processing circuit may be an FPGA (Field-Programmable Gate Array), which is a programmable logic device (PLD). In that case, the signal processing circuit includes a plurality of computation elements (e.g., general-purpose logics and multipliers) and a plurality of memory elements (e.g., look-up tables or memory blocks). Alternatively, the signal processing circuit may be a set of a general-purpose processor(s) and a main memory device(s). The signal processing circuit may be a circuit which includes a processor core(s) and a memory device(s). These may function as the signal processing circuit.

An antenna device according to an example embodiment of the present disclosure includes a multilayered WRG structure which permits downsizing, and thus allows the area of the face on which antenna elements are arrayed to be significantly reduced, as compared to a construction in which a conventional hollow waveguide is used. Therefore, a radar system incorporating the antenna device can be easily mounted in a narrow place such as a face of a rearview mirror in a vehicle that is opposite to its specular surface, or a small-sized moving entity such as a UAV (an Unmanned Aerial Vehicle, a so-called drone). Note that, without being limited to the implementation where it is mounted in a vehicle, a radar system may be used while being fixed on the road or a building, for example.

An antenna device according to an example embodiment of the present disclosure can also be used in a wireless communication system. Such a wireless communication system would include an antenna device according to any of the above example embodiments and a communication circuit (a transmission circuit or a reception circuit) connected to the antenna device. For example, the transmission circuit may be configured to supply, to a waveguide within the antenna device, a signal wave representing a signal for transmission. The reception circuit may be configured to demodulate a signal wave which has been received via the antenna device, and output it as an analog or digital signal.

An antenna device according to an example embodiment of the present disclosure can further be used as an antenna in an indoor positioning system (IPS). An indoor positioning system is able to identify the position of a moving entity, such as a person or an automated guided vehicle (AGV), that is in a building. An antenna device can also be used as a radio wave transmitter (beacon) for use in a system which provides information to an information terminal device (e.g., a smartphone) that is carried by a person who has visited a store or any other facility. In such a system, once every several seconds, a beacon may radiate an electromagnetic wave carrying an ID or other information superposed thereon, for example. When the information terminal device receives this electromagnetic wave, the information terminal device transmits the received information to a remote server computer via telecommunication lines. Based on the information that has been received from the information terminal device, the server computer identifies the position of that information terminal device, and provides information which is associated with that position (e.g., product information or a coupon) to the information terminal device.

Application examples of radar systems, communication systems, and various monitoring systems that include a slot array antenna having a WRG structure are disclosed in the specifications of U.S. Pat. No. 9,786,995 and U.S. Pat. No. 10,027,032, for example. The entire disclosure of these publications is incorporated herein by reference. A slot array antenna according to the present disclosure is applicable to each application example that is disclosed in these publications.

A waveguide device according to the present disclosure is usable in any technological field that utilizes electromagnetic waves. For example, it is available to various applications where transmission/reception of electromagnetic waves of the gigahertz band or the terahertz band is performed. In particular, they may be suitably used in onboard radar systems, various types of monitoring systems, indoor positioning systems, wireless communication systems, etc., where downsizing is desired.

This application is based on Japanese Patent Applications No. 2018-189124 filed on Oct. 4, 2018, the entire contents of which are hereby incorporated by reference.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A waveguide device used in propagation of an electromagnetic wave, the waveguide device comprising:
a first electrically conductive member including an electrically conductive surface and a first through hole;
a second electrically conductive member including a plurality of electrically conductive rods, each of the plurality of electrically conductive rods including a leading end opposing the electrically conductive surface, and a second through hole which overlaps the first through hole as viewed along an axial direction of the first through hole; and
an electrically-conductive waveguiding wall surrounding at least a portion of a space between the first through hole and the second through hole, the waveguiding wall being surrounded by the plurality of electrically conductive rods and allowing an electromagnetic wave to propagate between the first through hole and the second through hole; wherein
the waveguiding wall includes a stepped portion or a slope on an inner side.

2. The waveguide device of claim 1, wherein
the waveguiding wall is connected to the electrically conductive surface of the first electrically conductive member; and
an interspace is provided between the waveguiding wall and a surface of the second electrically conductive member that is opposed to the electrically conductive surface of the first electrically conductive member.

3. The waveguide device of claim 1, wherein
the waveguiding wall is connected to a surface of the second electrically conductive member that is opposed to the electrically conductive surface of the first electrically conductive member; and
an interspace is provided between the electrically conductive surface of the first electrically conductive member and the waveguiding wall.

4. The waveguide device of claim 1, wherein
the waveguiding wall is connected to the electrically conductive surface of the first electrically conductive member; and
a surface of the second electrically conductive member that is opposed to the electrically conductive surface of the first electrically conductive member is in contact with the waveguiding wall.

5. The waveguide device of claim 1, wherein
the waveguiding wall is connected to a surface of the second electrically conductive member that is opposed to the electrically conductive surface of the first electrically conductive member; and
the electrically conductive surface of the first electrically conductive member is in contact with the waveguiding wall.

6. The waveguide device of claim 1, wherein
the waveguiding wall includes a pair of first inner wall surfaces that are parallel or substantially parallel to an E plane, and a pair of second inner wall surfaces that are parallel or substantially parallel to an H plane; and
the stepped portion or slope is on each of the pair of first inner wall surfaces.

7. The waveguide device of claim 2, wherein
the waveguiding wall includes a pair of first inner wall surfaces that are parallel or substantially parallel to an E plane, and a pair of second inner wall surfaces that are parallel or substantially parallel to an H plane; and
the stepped portion or slope is on each of the pair of first inner wall surfaces.

8. The waveguide device of claim 3, wherein
the waveguiding wall includes a pair of first inner wall surfaces that are parallel or substantially parallel to an E plane, and a pair of second inner wall surfaces that are parallel or substantially parallel to an H plane; and
the stepped portion or slope is on each of the pair of first inner wall surfaces.

9. The waveguide device of claim 4, wherein
the waveguiding wall includes a pair of first inner wall surfaces that are parallel or substantially parallel to an E plane, and a pair of second inner wall surfaces that are parallel or substantially parallel to an H plane; and
the stepped portion or slope is on each of the pair of first inner wall surfaces.

10. The waveguide device of claim 5, wherein
the waveguiding wall includes a pair of first inner wall surfaces that are parallel or substantially parallel to an E plane, and a pair of second inner wall surfaces that are parallel or substantially parallel to an H plane; and
the stepped portion or slope is on each of the pair of first inner wall surfaces.

11. The waveguide device of claim 2, wherein
when viewed from a direction which is perpendicular to the electrically conductive surface of the first electrically conductive member, a region that is surrounded by the first and second through holes and an inner wall surface of the waveguiding wall has an H shape that includes a lateral portion extending along a first direction and a pair of vertical portions extending along a second direction which intersects the first direction, each of the vertical portions being connected by the lateral portion;
the inner wall surface of the waveguiding wall includes a pair of first inner wall surfaces that are parallel to the pair of vertical portions; and
the stepped portion or slope is on an edge of each of the pair of first inner wall surfaces by which the second electrically conductive member is located.

12. The waveguide device of claim 3, wherein
when viewed from a direction which is perpendicular to the electrically conductive surface of the first electrically conductive member, a region that is surrounded by the first and second through holes and an inner wall surface of the waveguiding wall has an H shape that includes a lateral portion extending along a first direction and a pair of vertical portions extending along a second direction which intersects the first direction, each of the vertical portions being connected by the lateral portion;
the inner wall surface of the waveguiding wall includes a pair of first inner wall surfaces that are parallel to the pair of vertical portions; and
the stepped portion or slope is on an edge of each of the pair of first inner wall surfaces by which the first electrically conductive member is located.

13. An antenna device comprising:
a first electrically conductive member including a first electrically conductive surface on a front side, a second electrically conductive surface on a rear side, and a slot extending through and between the first electrically conductive surface and the second electrically conductive surface; wherein
the first electrically conductive surface has a shape that defines a horn surrounding the slot;
the horn includes a pair of inner wall surfaces extending along a first direction which is perpendicular or substantially perpendicular to an E plane of the slot; and
a root of each of the pair of inner wall surfaces includes a protrusion extending along the first direction.

14. The antenna device of claim 13, further comprising:
a second electrically conductive member which includes a third electrically conductive surface opposing the second electrically conductive surface; and
the second electrically conductive member includes a through hole that allows an electromagnetic wave to propagate reciprocally between itself and the slot, or a waveguide member defining a ridge waveguide that allows an electromagnetic wave to propagate reciprocally between itself and the slot.

15. An antenna device comprising:
an electrically conductive member including a first electrically conductive surface on a front side, a second electrically conductive surface on a rear side, and one or more slots extending through and between the first electrically conductive surface and the second electrically conductive surface; wherein
the first electrically conductive surface has a shape that defines: one or more horns respectively surrounding the one or more slots; and two recesses located on opposite sides of the one or more horns;
the one or more horns and the two recesses are arranged side by side in one row, with electrically conductive walls being located therebetween; and
each electrically conductive wall located between the one or more horns and two recesses includes a central portion and sites on opposite sides of the central portion, the central portion and sites being distanced by two grooves.

16. The antenna device of claim 15, further comprising:
a second electrically conductive member which includes a third electrically conductive surface opposing the second electrically conductive surface; and
the second electrically conductive member includes a through hole that allows an electromagnetic wave to propagate reciprocally between itself and the slot or slots, or a waveguide member defining a ridge waveguide that allows an electromagnetic wave to propagate reciprocally between itself and the slot or slots.
